(19) United States
(12) Patent Application Publication
(10) Pub. No.: US 2019/0213476 A1
(43) Pub. Date: Jul. 11, 2019

(54) DETERMINING STRATEGIC DIGITAL CONTENT TRANSMISSION TIME UTILIZING RECURRENT NEURAL NETWORKS AND SURVIVAL ANALYSIS

(71) Applicant: Adobe Inc., San Jose, CA (US)

(72) Inventors: Harvineet Singh, Bellandur (IN); Sahil Garg, Maur Mandi (IN); Neha Banerjee, Kolkata (IN); Moumita Sinha, Bangalore (IN); Atanu Sinha, Bangalore (IN)

(21) Appl. No.: 15/867,169

(22) Filed: Jan. 10, 2018

(51) Int. Cl. G06N 3/08

(52) U.S. Cl. CPC G06N 3/08

(57) ABSTRACT

Methods, systems, and non-transitory computer readable storage media are disclosed for determining and applying digital content transmission times using machine-learning. For example, in one or more embodiments, the disclosed system trains a recurrent neural network based on past electronic messages for a user that have been partitioned into a plurality of time bins. Additionally, in one or more embodiments, the system utilizes the trained recurrent neural network to generate predictions of engagement metrics (e.g., a hazard metric based on survival analysis or interaction probability metric) for sending a new electronic message within the plurality of time bins. The system then executes the digital content campaign by selecting a time bin based on the predicted engagement metrics and then sending the new electronic message at a send time corresponding to the selected time bin.

### BACKGROUND AND RELEVANT ART

Recent years have seen significant improvement in computer systems for generating and executing digital content campaigns across computer networks to deliver digital content to client devices. Indeed, publishers now utilize various hardware and software platforms to generate digital content campaigns (e.g., campaigns comprising one or more digital design assets such as digital images, videos, and/or audio) and then implement the campaigns by distributing digital content to client computing devices. For example, publishers can utilize digital content systems to generate digital content campaigns for the distribution of digital media via email messaging to targeted computing devices of particular users.

Although conventional email digital content campaign systems can generate and disseminate digital content across computer networks, these systems have a number of shortcomings. For example, conventional email digital content campaign systems struggle to identify and implement accurate and efficient digital content send times (i.e., time of transmission). Inasmuch as digital content campaign systems provide digital content to computing devices instantaneously (or near-instantaneously) the digital content send time can have significant impacts on computing systems implementing digital content campaigns. For example, some conventional email digital content campaign systems transmit digital content to client devices at times when the digital content is unlikely to be accessed or acted upon thus resulting in transmission and storage of large volumes of digital content that users fail to open, access, or utilize.

Accordingly, implementation of inaccurate digital content transmission times can lead to unnecessary and inefficient waste of computing and networking resources. In particular, transmitting digital content at incorrect or inaccurate times often leads to duplication in digital content generation, transmission, and storage. Indeed, as mentioned, incorrect transmission times often leads to reduced access rates at client devices, resulting in unnecessary transmission and storage of digital content. Moreover, when digital content access rates are reduced, publishers often re-transmit digital content and/or expand the number of targeted computing devices to satisfy digital campaign requirements. This results in additional burdens on computer processing and networking assets for publisher and recipient computing devices/networks.

In addition, conventional email digital content campaign systems are also inflexible. For example, some digital content campaign systems predict a transmission time for digital messages based on factors determined by a campaign designer based on analysis of historical data. Although such systems can utilize these determined factors to select a transmission time for digital content, they are inflexible and still suffer from inaccuracies. Indeed, such systems are rigidly bound to selected factors generally identified by campaign designers (based on limited historical data at the time the campaign designer generates the campaign) and, therefore, are generally incapable of flexibly applying individualized features in deciding when to provide digital content to client devices.

These and other disadvantages exist with respect to conventional digital email content campaign systems.

### SUMMARY

One or more embodiments provide benefits and/or solve one or more of the foregoing or other problems in the art with systems, methods, and non-transitory computer readable storage media for determining and applying strategic digital content transmission times using a recurrent neural network. In particular, the disclosed systems can utilize a recurrent neural network to flexibly and accurately determine and execute digital content transmission times within a digital content campaign based on one or more predicted engagement metrics for particular transmission time bins. For example, the disclosed systems can utilize the recurrent neural network to generate a predicted engagement metric that reflects a predicted time for user interaction, such as a hazard metric resulting from a survival analysis. Further, the disclosed systems can provide an option to flexibly optimize for various objectives, such as increasing open probability or decreasing time to open sent messages. Moreover, the disclosed systems can utilize the recurrent neural network to flexibility, and automatically, learn significant features, including features only apparent from sequential analysis of data from prior messages transmitted to a particular user.

To illustrate, in one or more embodiments, the disclosed system trains a recurrent neural network for a user using past electronic messages for the user that have been partitioned into a plurality of time bins based on corresponding transmission timestamps. The disclosed system uses the recurrent neural network to predict an engagement metric in connection with sending a new electronic message to a client device of the user. For example, the disclosed system can use the recurrent neural network to predict an interaction probability with the new electronic message for the user. Alternatively, the disclosed system can use the recurrent neural network with a survival function to predict a time-to-interact (e.g., hazard metric) with the new electronic message for the user. In one or more embodiments, the disclosed system uses the predicted engagement metric to determine a time bin and then executes a digital content campaign by sending the new electronic message during the determined time bin. By using a recurrent neural network trained for the user based on past electronic messages for the user to predict an engagement metric for a new electronic message, the disclosed system is able to determine a transmission time that optimizes the engagement metric, improves accuracy, reduces wasted resources, and increases flexibility.

Additional features and advantages of one or more embodiments of the present disclosure will be set forth in the description which follows, and in part will be obvious from the description, or may be learned by the practice of such example embodiments.

### BRIEF DESCRIPTION OF THE DRAWINGS

Various embodiments will be described and explained with additional specificity and detail through the use of the accompanying drawings in which:

FIG. 1 illustrates an environment in which a campaign management system can operate in accordance with one or more embodiments;

FIG. 2 illustrates a schematic diagram of training and utilizing a recurrent neural network for determining a transmission time for a new electronic message in accordance with one or more embodiments.

FIG. 3 illustrates a schematic diagram of training a recurrent neural network for predicting an engagement metric in connection with new electronic messages for a user in accordance with one or more embodiments;

FIG. 4 illustrates a schematic diagram of training and utilizing a recurrent neural network to predict engagement metrics for electronic messages in accordance with one or more embodiments;

FIGS. 5A-5C illustrate user interfaces for identifying and presenting strategic transmission times for electronic messages in a digital content campaign in accordance with one or more embodiments;

FIG. 6 illustrates a schematic diagram of the campaign management system of FIG. 1 in accordance with one or more embodiments;

FIG. 7 illustrates a flowchart of a series of acts in a method of determining and applying strategic digital content transmission times using machine-learning in accordance with one or more embodiments; and

FIG. 8 illustrates a block diagram of an exemplary computing device in accordance with one or more embodiments.

### DETAILED DESCRIPTION

One or more embodiments of the present disclosure include a campaign management system that determines transmission times for electronic messages in a digital content campaign utilizing a recurrent neural network. Specifically, the campaign management system utilizes a recurrent neural network to predict transmission times for new electronic messages by analyzing past electronic messages for a user in sequential order to generate a predicted engagement metric. By utilizing a recurrent neural network to predict engagement metrics for new electronic messages based on past electronic messages for the user, the campaign management system can improve the accuracy, flexibility, and efficiency of computing systems implementing digital content campaigns.

To illustrate, in one or more embodiments, the campaign management system trains a recurrent neural network for a group of users (e.g., a target audience) utilizing a plurality of past electronic messages that have been partitioned into a plurality of time bins. Using the recurrent neural network, the campaign management system generates a prediction of an engagement metric. Specifically, the campaign management system can predict, for each time bin, a hazard metric (e.g., a hazard metric from a survival analysis) or an interaction probability metric in connection with a new electronic message for a user in the group of users. Furthermore, the campaign management system can select a time bin from the time bins according to the predicted engagement metrics. The campaign management system can execute a digital content campaign by sending the new electronic message to a client device of the user based on the selected time bin.

As mentioned, the campaign management system trains a recurrent neural network to generate predicted engagement metrics for a user. In particular, in one or more embodiments, the campaign management system first partitions a plurality of past electronic messages into a plurality of time bins based on timestamps corresponding to the past electronic messages. Specifically, the campaign management system can partition past electronic messages into time bins (and adjust the size or time range for the time bins) to achieve a particular grouping proportion of the past electronic messages (e.g., time bins with an equal number of past electronic messages). In this manner, the campaign management system can control for publisher preferences in send times in determining an engagement metric for a particular user.

As just mentioned, the plurality of past electronic messages includes past electronic messages sent to a particular user (i.e., to a client device of the user). The campaign management system can use the past electronic messages sent to the user to train the recurrent neural network to determine important features specific to the user and the past messages sent to the user. For example, utilizing the recurrent neural network, the campaign management system can identify significant features based on sequential data from past campaigns and prior messages to the user.

Additionally, the campaign management system trains the recurrent neural network based on different engagement metrics. For instance, the campaign management system can train the recurrent neural network to output predictions for time-to-interact metric (e.g., hazard metric) or interaction probability metrics with respect to a given electronic message. When training for a time-to-interact with electronic messages, the campaign management system can use a recurrent neural network with a survival algorithm for outputting a hazard metric that indicates a measure of time for a user interaction. Similarly, when training for an interaction probability with electronic messages, the campaign management system can use a recurrent neural network without a survival algorithm (e.g., trained for interaction classification) that outputs an interaction probability metric that indicates a probability of a user interaction with an electronic message.

Upon training the recurrent neural network for the user and for a specific engagement metric, in one or more embodiments, the campaign management system uses the trained recurrent neural network to automatically generate predicted engagement metrics for a new electronic message to a particular user in a digital content campaign. In particular, the campaign management system can analyze each time bin and generate a predicted engagement metric corresponding to each time bin. Specifically, the campaign management can determine an engagement metric that indicates a predicted performance of the new electronic message if sent within the time bin. The campaign management system can rank the time bins based on the generated engagement metrics and then select one or more time bins for sending the new electronic message.

In one or more embodiments, the campaign management system executes a digital content campaign that includes a plurality of electronic messages based on one or more campaign parameters. For example, the campaign management system can use campaign parameters that limit the number of messages or frequency of messages to determine the transmission times for the electronic messages. Furthermore, the campaign management system can execute the campaign by scheduling and sending the messages according to the determined transmission times.

As mentioned, the campaign management system provides a number of advantages over conventional systems. For example, the campaign management system can improve the accuracy and efficiency of computing systems implementing digital design campaigns utilizing transmission times for digital content. In particular, the campaign management system can more accurately predict engagement metrics, such as a hazard metric (e.g., that indicates an instantaneous probability that a user will interact with digital content, allowing for transmission times that correspond with opening times) or an interaction probability metric (e.g., that indicates a probability of interaction with digital content, allowing for transmission times that will increase response). Increasing the accuracy of transmission times in relation to one or more engagement metrics results in more efficient use of computing resources in conducting digital content campaigns. In particular, the campaign management system can reduce the amount of digital content transmitted by a computing device across a computing network (e.g., the digital content required to satisfy digital content campaign requirements) and the amount of computer storage required to manage and store such digital content.

In addition, the campaign management system further improves flexibility of computing devices implementing digital content campaigns. For example, the campaign management system can utilize a recurrent neural network to automatically identify significant features for individual users. Indeed, the campaign management system can train a recurrent neural network to identify the unique features for modeling user responses for a specific user or group of users in selecting and implementing a transmission time as part of a digital content campaign. This includes features gleaned from sequential analysis of prior messages sent to the user (or group of users).

In addition, the campaign management system can automatically incorporate up-to-date (e.g., real-time) digital data regarding individual users in identifying significant features. For example, as the campaign management system detects individual user interactions with digital content, the campaign management system can update training of the recurrent neural network to identify any additional features indicated by the detected interactions. Thus, for instance, the campaign management system can analyze user responses to an electronic message sent the previous day before executing a digital content campaign. Conventional systems tend to ignore such data points because not much time has elapsed for customers to respond. Accordingly, the campaign management system can not only automatically identify significant features for modeling responses for individual users (or groups of users), but can automatically modify which features the system determines to be significant based on additional user interactions with electronic messages sent to the user(s).

Furthermore, the campaign management system also improves flexibility by providing for options to optimize various types of engagement metrics. For instance, as mentioned above, the campaign management system can allow for selection among various engagement metric types. For example, the campaign management system can allow for optimization based on increasing open probability or decreasing time to open.

As illustrated by the foregoing discussion, the present disclosure utilizes a variety of terms to describe features and advantages of the campaign management system. Additional detail is now provided regarding the meaning of such terms. For example, as used herein, the terms “electronic message” and “message” refer to an electronic communication that includes digital content. For example, an electronic message can include an email. An electronic message can include digital content such as digital text, digital images, or digital video associated with a digital content campaign. In addition, as used herein, the term “new electronic message” refers to a generated, proposed, future, or unsent electronic message for one or more recipient users. A new electronic message may include content that has previously been used, new content, or a combination of previously used/new content. Thus, a new electronic message can be a newly generated message or an already existing message (or previously sent message) to be re-sent as part of a digital content campaign.

Additionally, the terms “digital content campaign” and “campaign” refer to a series of activities, parameters, and/or rules used in connection with providing digital content corresponding to a product, service, group, individual, entity, or other category. For instance, a digital content campaign can include electronic messages comprising digital content about a product, service, group, individual, entity, or other category. Moreover, a digital content campaign can include campaign parameters such as a target audience, budget, or constraints for delivering digital content. Executing the digital content campaign, therefore, can include sending the electronic messages to a target audience that can include recipients that share one or more characteristics according to one or more campaign parameters.

As used herein, the term “recurrent neural network” refers to an artificial neural network (e.g., a neural network that performs analytical tasks for elements in a sequential order based on computations from previous elements). In particular, a recurrent neural network includes an artificial neural network that uses sequential information associated with a plurality of electronic messages within a chronological timeline, and in which an output of a current step is dependent on computations for previous steps. For example, the campaign management system trains and uses a recurrent neural network for a user to predict user interactions with electronic messages based on transmission times of the electronic messages and learned behaviors of the user. Specifically, a trained recurrent neural network sequentially analyzes electronic messages to learn important features that indicate a pattern of user interactions with the electronic messages (e.g., based on when the electronic messages were sent and preferences or tendencies of the user).

As used herein, the term “input attributes” refer to characteristics or traits of electronic messages that a recurrent neural network uses in predicting performance of electronic messages. In particular, input attributes can include information regarding electronic messages provided as input to a recurrent neural network. Specifically, input attributes for a message can include user interactions or send characteristics associated with one or more electronic messages message (e.g., a current electronic message or previously transmitted electronic messages). For example, input attributes can include analytics data including, but not limited to, user interactions with past electronic messages, user preferences, detected user actions, or message details or characteristics. The recurrent neural network can thus determine important features for predicting user interactions relative to electronic messages based on the input attributes. In one or more embodiments, input attributes for a message include a transmission time or time bin of the message. Input attributes of a message can also include properties of the transmission (e.g., content of the message or information sent with the message) such as a subject line of the message or images (e.g., banner images).

As described in greater detail below, a recurrent neural network can include a plurality of layers. The term refers to analytical elements within a neural network. In particular, a layer can include interconnected nodes containing an activation function. The recurrent neural network can utilize layers to conduct analysis at different levels to determine significant features corresponding to a particular output. To illustrate, the layers can include a dense layer (or fully connected layer) with an activation function and/or a survival layer with a survival function. As used herein, the term “survival layer” refers to a layer that utilizes a survival function to generate a hazard metric (e.g., a hazard rate or hazard ratio). As used herein, the term “survival function” refers to a function that is a property of a variable (e.g., message) that maps an event or set of events onto time. In particular, a survival function captures the probability that an analyzed message survives (e.g., no interaction with the message) beyond a given specified time. In one specific example, a survival function outputs a hazard metric, which can include a hazard rate or a hazard ratio, for an electronic message for a user.

As used herein, the term “engagement metric” refers to a measurement of user interactions corresponding to an electronic message of a digital content campaign. An engagement metric can include a hazard metric that indicates an instantaneous probability of a user interaction with an electronic message for a user for a given time bin. For example, as used herein, a “hazard metric” includes the instantaneous probability that, for an electronic message sent within a time bin (and given a recipient has yet to open/interact with the message by time t), the recipient will open the electronic message instantaneously after time t. Alternatively, an engagement metric can include an interaction probability. As used herein, an “interaction probability” refers to the probability of a user interacting with an electronic message if the message is sent within a given time bin.

As used herein, the term “time bin” refers to a range of time. In particular, in one or more embodiments, the term “time bin” includes a range of time within a planning window (e.g., a range of time within a time period for executing a digital content campaign). The term “time bin” includes a range of time within which a set of electronic messages have been sent. In particular, the campaign management system can group past electronic messages for a plurality of users into a plurality of time bins based on the timestamps of the electronic messages for use in training the recurrent neural network. The campaign management system can partition messages into a plurality of time bins such that each time bin includes the same (or approximately the same) number of electronic messages. Alternatively, the campaign management system can partition messages into a plurality of time bins, each time bin corresponding to a predetermined, fixed time period (e.g., a specific time range of a specific day of the week, month, or year).

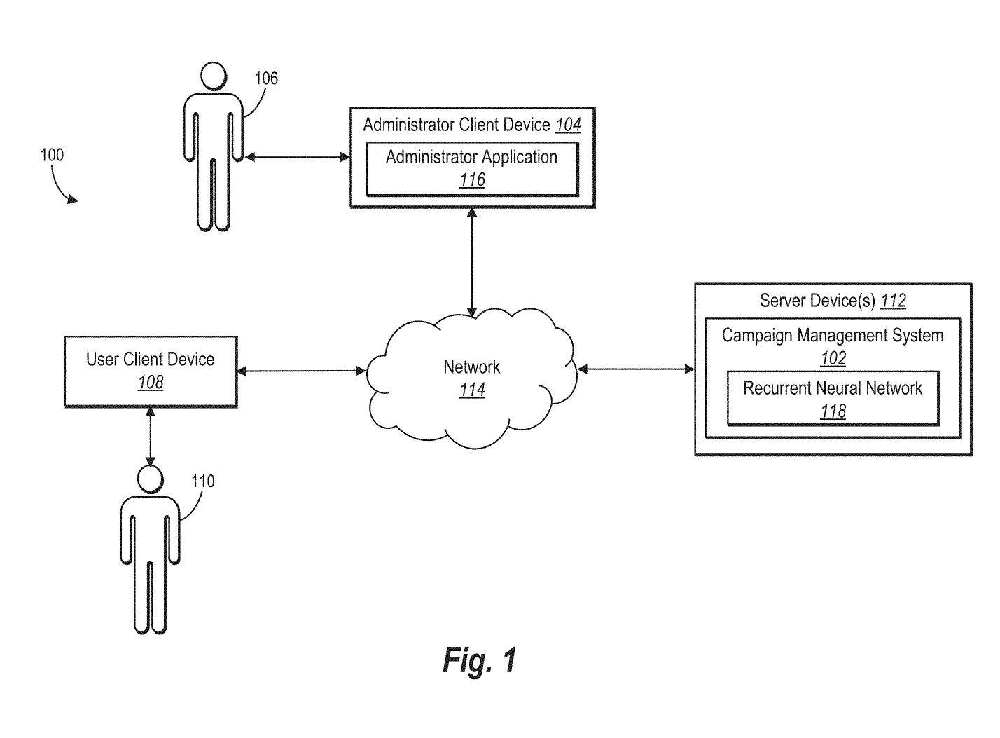

Referring now to the figures, FIG. 1 illustrates an embodiment of an environment in which a campaign management system 102 operates. In particular, the environment 100 includes an administrator client device 104 associated with an administrator 106, a user client device 108 associated with a user 110, and server device(s) 112 in communication via a network 114. Moreover, as shown, the administrator client device 104 includes an administrator application 116.

Furthermore, the server device(s) 112 includes the campaign management system 102, which includes a recurrent neural network 118. As mentioned above, the campaign management system 102 utilizes the recurrent neural network to determine transmission times for sending new electronic messages to users based on past electronic messages for the users.

According to one or more embodiments, the campaign management system 102 allows the administrator 106 to administer a digital content campaign associated with a product, service, individual, entity, or other category. For example, the digital content campaign may be a marketing campaign to promote and distribute information associated with a product, service, or business. Administering the digital content campaign can include creating digital content and distributing the digital content in the campaign. To illustrate, the administrator 106 can use the administrator client device 104 to communicate with the campaign management system 102 on the server device(s) 112 via the network 114 to provide and obtain information associated with administering the campaign.

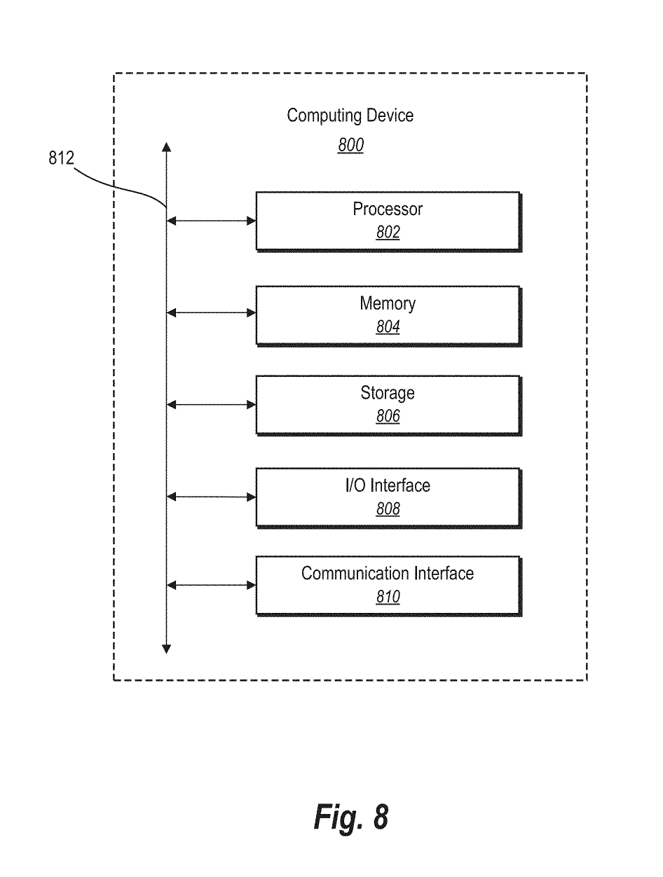

As described in more detail below, the administrator client device 104 can include a computing device capable of performing operations associated with managing and administering a digital content campaign. For example, the administrator client device 104 can include a smartphone, tablet, desktop computer, laptop computer, or other device that is able to access electronic messages via the network 114 and receive user input to interact with the electronic messages (e.g., any of the devices discussed below in reference to FIG. 8). The administrator client device 104 can include one or more applications (e.g., administrator application 116) by which the administrator 106 can review, plan, modify, and/or execute digital content campaigns. To illustrate, the administrator 106 can use the administrator application 116 to access the campaign management system 102 via the network 114.

In one or more embodiments, the campaign management system 102 facilitates the administration of campaigns by obtaining and analyzing analytics data associated with digital content campaigns. For instance, the campaign management system 102 can obtain information associated with past electronic messages associated with the digital content campaigns for a plurality of recipient users. Additionally, the campaign management system 102 can obtain information indicating user interactions with the past electronic messages for the plurality of recipient users. In at least some instances, the campaign management system 102 assists the administrator 106 in administering digital content campaigns such that the campaign management system 102 collects the information associated with the campaigns.

In other embodiments, the campaign management system 102 obtains the information associated with the campaigns from other systems or devices. For example, the administrator client device 104 (or a system associated with the administrator client device 104) may collect the analytics data for the digital content campaigns and then provide the analytics data to the campaign management system 102 via the network 114. Alternatively, the campaign management system 102 may receive the analytics data for the digital content campaigns from a third-party system that is separate from the server device(s) 112 and the administrator client device 104.

Once the campaign management system 102 has obtained the analytics data associated with the digital content campaigns, the campaign management system 102 analyzes the analytics data using the recurrent neural network 118. The campaign management system 102 trains the recurrent neural network 118 for a particular user by analyzing past messages for the user. The campaign management system 102 can include a plurality of recurrent neural networks, with each recurrent neural network trained for a separate user. Accordingly, the campaign management system 102 can train a plurality of recurrent neural networks to send electronic messages to a plurality of users in connection with one or more digital content campaigns.

In one or more embodiments, the campaign management system 102 groups past electronic messages for a plurality of recipient users into time bins based on the timestamps of the messages. The campaign management system 102 can then train the recurrent neural network 118 for a user by analyzing the past messages for the user according to the time bins in which the past messages for the user are grouped. Once trained, the recurrent neural network 118 can generate engagement metrics for scoring the time bins in connection with a new electronic message.

Indeed, the campaign management system 102 can use the engagement metrics of the recurrent neural network 118 to determine a schedule (e.g., transmission times) for sending one or more new electronic messages in a digital content campaign to the user client device 108. According to one or more embodiments, the campaign management system 102 provides the schedule for the digital content campaign to the administrator client device 104 to execute the campaign. The administrator 106 can execute the campaign for the user using the administrator application 116 by sending one or more electronic messages to the user client device 108 according to the provided schedule. In one or more alternative embodiments, the campaign management system 102 automatically executes the digital content campaign in response to determining the schedule for the user by sending one or more electronic messages from the campaign to the user client device 108 and without requiring the administrator 106 to provide additional input.

In one or more embodiments, when sending an electronic message to the user 110, the campaign management system 102 sends the electronic message to at least the user client device 108. Additionally, the campaign management system 102 can send the electronic message to any number of client devices associated with the user. For instance, the campaign management system 102 can send the electronic message to one or more client devices via a user account of the user 110. The user 110 can then access the electronic message from one or more client devices (including the user client device 108) from which the user 110 can access the user account.

According to one or more embodiments, the user client device 108 includes a computing device that allows the user 110 to access and interact with electronic messages in a digital content campaign. For example, the user client device 108 can include a computing device (e.g., any of the devices discussed in reference to FIG. 8) that is able to access electronic messages via the network 114 and receive user input to interact with the electronic messages. The user client device 108 can include one or more applications by which the user 110 can access and interact with the electronic messages such as an email application. Via the email application, the user 110 can open emails and interact with content within the emails. Additionally, the one or more applications can include an application (e.g., a web browser) that allows the user client device 108 to access external content from electronic messages.

Although the environment 100 of FIG. 1 is depicted as having various components, the environment 100 may have any number of additional or alternative components (e.g., any number of server devices, client devices, or other components in communication with the campaign management system 102). Accordingly, the campaign management system 102 can utilize any number of recurrent neural networks to determine transmission times for sending electronic messages to any number of users. Similarly, the campaign management system 102 can provide campaign management services to any number of administrators via any number of administrator client devices. Furthermore, more than one component or entity in the environment 100 can implement the operations of the campaign management system 102 described herein. Indeed, the campaign management system 102 can alternatively be implemented entirely (or in part) on the administrator client device 104 or as part of another component or system.

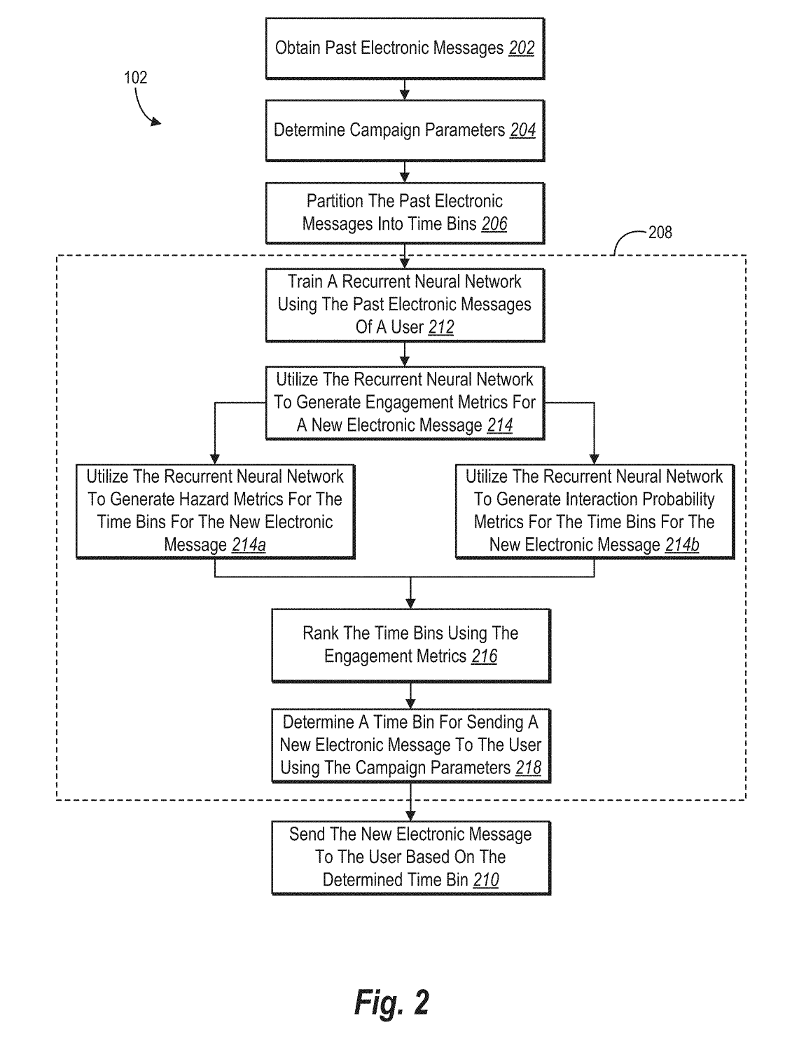

As mentioned previously, the campaign management system can train and utilize a recurrent neural network to determine transmission times for electronic messages in a digital content campaign. FIG. 2 illustrates training and utilizing a recurrent neural network for determining a transmission time (e.g., send time) for a new electronic message for a user in accordance with one or more embodiments. As an overview, FIG. 2 shows that the campaign management system 102 first performs an act 202 of obtaining past electronic messages (which include past electronic messages for the user and past electronic messages for other users). Additionally, the campaign management system 102 performs an act 204 of determining campaign parameters of the digital content campaign. The campaign management system 102 then performs an act 206 of partitioning the past electronic messages into time bins. The campaign management system 102 also includes a step 208 for utilizing a recurrent neural network and the past electronic messages for the user to determine a time bin of the plurality of time bins for sending a new electronic message for the user. Moreover, the campaign management system 102 then performs an act 210 of sending the new electronic message based on the determined time bin.

As just mentioned, in relation to FIG. 2 the campaign management system 102 performs the act 202 of obtaining past electronic messages for a plurality of users. The campaign management system 102 can obtain the past electronic messages from a repository of electronic messages. The repository can be locally stored by the campaign management system 102 or as part of a third-party system. Past electronic messages for any particular user can be identified from the past electronic message for the plurality of users.

In one or more embodiments, the campaign management system 102 performs an act 204 of determining campaign parameters for a digital content campaign. As mentioned above, the campaign management system 102 can determine and utilize a variety of campaign parameters that cause the campaign management system 102 to determine how to manage and/or execute the campaign. For example, the campaign management system can determine parameters such as campaign length (e.g., a planning window for the campaign), number of messages, number of recipients, and frequency of messages for the campaign. The campaign parameters can also include a target audience or segment.

The campaign management system can identify campaign parameters in a variety of ways. For example, in one or more embodiments, the campaign management system 102 identifies campaign parameters from an administrator of the digital content campaign. In other embodiments, the campaign management system determines campaign parameters algorithmically. To illustrate, the campaign management system 102 can determine the number and frequency of messages for a campaign based on models that indicate user response fatigue in connection with receiving email messages. In another example, the campaign management system 102 can determine a target audience or segment based on characteristics received from the administrator or based on characteristics of content of messages in the campaign.

As part of identifying campaign parameters in the act 204, the campaign management system can also determine a type of engagement metric. For instance, the campaign management system 102 can determine a type of engagement metric for all or part of a digital content campaign. The type of engagement metric can indicate whether the campaign management system 102 trains the recurrent neural network to output an interaction probability metric based on an interaction classification or a hazard metric based on survival analysis.

In general, survival analysis is an area of statistical modeling primarily interested in modeling the time to an event. Survival analysis utilizes a time-to-interact model to estimate a survival probability—a probability that an individual will survive beyond a time t (i.e., not experience an event of interest by t). Historically, the event of interest was the death of medical patients; however, the campaign management system 102 adapts survival analysis for an event of interacting with an electronic message by a recipient. In other words, the campaign management system 102 can utilize survival analysis to estimate a probability the recipient of an electronic message will not interact with the message before a time t.

Using survival analysis, as described briefly above, the campaign management system 102 can generate a hazard metric. Specifically, a hazard metric includes the probability that, given a recipient user has yet to experience the event (e.g., opening a message) by time t, the recipient will experience the event instantaneously after time t. In one example, a hazard metric can include a hazard rate, which refers to the instantaneous probability of a user opening a message given that the message has not been opened until time t. More specifically, the hazard rate includes a time element that indicates the instantaneous probability of the user interacting with the message within a certain time based on the message being sent within the time bin. Accordingly, the higher the hazard rate for a time bin, the higher the chances are of the user interaction (e.g., email being opened) within a certain amount of time when the message is sent during that time bin for a user.

Due to the origins of survival analysis, hazard functions generally assume that all individuals will eventually experience the event. However, this is not the case in the context of electronic messages as many recipients will delete or otherwise not view/open/interact with the received message. The campaign management system 102 can modify the survival analysis to account for those recipients who are expected to never open the electronic message. In one or more embodiments, the campaign management system 102 determines the probability that a particular recipient will interact with a received electronic message based on the input attributes corresponding to the past electronic messages. The campaign management system 102 can introduce this probability into the survival function as a mixture probability so the time-to-interact for a particular recipient is dependent on attributes that affect whether the particular recipient is likely to interact with the received message and/or attributes that affect the time in which the particular recipient will open the message.

In one or more embodiments, a hazard metric is a hazard ratio, which refers to the time-independent component of the hazard rate. To illustrate, a higher hazard ratio indicates a higher instantaneous risk of occurrence of the event (e.g., opening a message). For instance, the campaign management system 102 can obtain a hazard ratio by dividing a given hazard rate by a standard time period (as determined by the campaign management system 102 based on other campaign parameters past electronic messages).

In one or more embodiments, an interaction probability metric refers to the probability that a given interaction with a message will occur given that the message is sent within a time bin. To illustrate, an open probability metric indicates the probability that a user will open the message when the message is sent within a given time bin. A higher open probability metric indicates a higher probability, and a lower open probability metric indicates a lower probability.

The campaign management system can determine a type of engagement metric to optimize in selecting one or more transmission times for a user within a digital content campaign. For example, in one or more embodiments, an administrator selects between a hazard metric or an interaction probability metric. In some embodiments, the campaign management system can automatically select (or suggest) a type of engagement metric. For example, the campaign management system can select a type of engagement metric based on details regarding a digital advertising campaign (e.g., select a hazard metric for time-sensitive digital content, such as a flash sale message, or select an interaction probability metric for informational digital content) and/or based on historical analytics data (e.g., information indicating that a particular product, service, entity, or advertisement has produced higher open rates utilizing a particular type of engagement metric).

The campaign management system 102 also determines a planning window for the campaign. The planning window indicates a time period for which the campaign management system 102 will execute the campaign (or otherwise provide electronic messages according to scheduled transmission times). For instance, the planning window can indicate a specific time period with a beginning date and an ending date (e.g., December 1 to December 31). Alternatively, the planning window can indicate a length of time from a starting date yet to be determined for the campaign. The campaign management system 102 can determine the planning window based on a specific selection by an administrator or based on similar and/or previous campaigns.

To illustrate an example of the act 204 of determining campaign parameters, in one or more embodiments, the administrator provides campaign management system with a group of customers to send messages to (e.g., a segment, email list, or set of characteristics). The administrator indicates a type of engagement metric (e.g., hazard metric), and selects a total number of messages (e.g., K messages) to be sent throughout the planning window (e.g., 1 weeks' time). Further, the administrator specifies constraints on the maximum frequency (e.g., maximum number of messages to be sent per day). The campaign management system then utilizes these campaign parameters to determine transmission times. As mentioned above, these parameters can also be determined algorithmically (rather than directly from an administrator).

As shown in FIG. 2, the campaign management system 102 can also perform the act 206 of partitioning the past electronic messages into time bins. In particular, the campaign management system 102 partitions the past electronic messages for the plurality of users into a plurality of time bins based on timestamps corresponding to the past electronic messages. Because the past electronic messages for the plurality of users include the past electronic messages for the user, the campaign management system 102 also partitions the past electronic messages for the user into the time bins. In one or more embodiments, the campaign management system 102 partitions a portion of the past electronic messages while holding a separate portion for testing (e.g., testing accuracy of the trained recurrent neural network).

In one or more embodiments, partitioning the past electronic messages into time bins includes partitioning the past electronic messages into each time bin according to a grouping proportion. In at least some embodiments, a “grouping proportion” refers to an equal or approximately equal number of messages into each time bin. For example, the campaign management system 102 can partition the past electronic messages evenly into non-overlapping time bins to take into account variations of open rates of the past electronic messages due to the send times of the past electronic messages. To illustrate, the campaign management system 102 can dynamically adjust the time bins (e.g., modify the time range of each time bin) such that the resulting time bins have an equal number of past electronic messages. To illustrate, the campaign management system 102 can generate a first time bin so that the first time bin includes the first N number of past electronic messages from a first time range of a first length, and the campaign management system 102 can generate a second time bin so that the second time includes another N number of past electronic messages from a second time range of a second length. In the foregoing example, the past electronic messages in the second time bin can follow the past electronic messages in the first time bin chronologically. Accordingly, the time ranges for the time bins can be arbitrary (to satisfy the grouping proportion), such that the first length may be different than the second length depending on the timestamps of the past electronic messages that are in the first and second time bins.

In alternative embodiments, partitioning the past electronic messages includes partitioning the past electronic messages into time bins according to fixed, predetermined time ranges. For example, rather than partitioning the past electronic messages equally into a plurality of time bins, the campaign management system 102 can partition the electronic messages into time bins that each correspond to specific time ranges. To illustrate, the campaign management system 102 can partition past electronic messages with timestamps that fall within a first time range into a first time bin and past electronic messages with timestamps that fall within a second time range into a second time bin. In such a case, the time bins may not have equal numbers of past electronic messages, but the time ranges corresponding to the time bins are not dynamic and are set beforehand. Furthermore, the fixed time ranges corresponding to the time bins may be equal or unequal (e.g., the time bins may correspond to specific time ranges manually designated by an administrator).

Additionally, the campaign management system 102 can partition the past electronic messages in connection with an analysis window. In particular, in one or more embodiments, the campaign management system 102 can set an analysis window defining a time range for analyzing past electronic messages. The campaign management system 102 can then select and utilize past electronic messages falling within the analysis window.

The campaign management system 102 can determine an analysis window based on user input (e.g., based on input from an administrator). Moreover, the campaign management system 102 can determine the analysis window based on a plurality of electronic messages (e.g., a time range for electronic messages previously sent to a particular user or a plurality of users). In other embodiments, the analysis window is based on the planning window (e.g., the planning window and the analysis window are the same length). To illustrate, if the planning window is for a month-long campaign, the campaign management system 102 can determine that the analysis window is covers a month of past electronic messages.

In one or more embodiments, the number of time bins is based on the length of the analysis window. Specifically, the campaign management system 102 can determine the number of time bins based on the number of past electronic messages within the analysis window. For instance, if the analysis window covers a period of time with N number of past messages, the campaign management system 102 can partition the past messages into X time bins. If the analysis window covers a period of time with 2N number of past messages, the campaign management system 102 can partition the past messages into 2X time bins. Accordingly, the number of time bins may be directly proportional (or otherwise correlate) to the number of past electronic messages within the analysis window.

The administrator can also set a precision of the scheduling to indicate how much flexibility the campaign management system 102 has in scheduling the sending of new electronic messages. In particular, the precision of a campaign indicates a threshold or range of time bin sizes so that the campaign management system 102 analyzes the transmission times of messages at a particular level of detail. To illustrate, the campaign management system 102 can determine the scheduling precision to be a minimum of one-hour segments, five-minute segments, etc.

The analysis window and/or the precision for analyzing a campaign may also be constrained by additional factors. To illustrate, the campaign management system 102 can apply constraints or limitations to scheduling message transmission times based on server capabilities, user preferences associated with a user profile (e.g., opt-out preferences for specific types of messages, user preferences related to preferred time ranges), or other limitations. To illustrate, the campaign management system 102 can limit transmission times based on server limits so as to prevent the campaign management system 102 from overloading server(s) that send the messages to a plurality of users for a campaign.

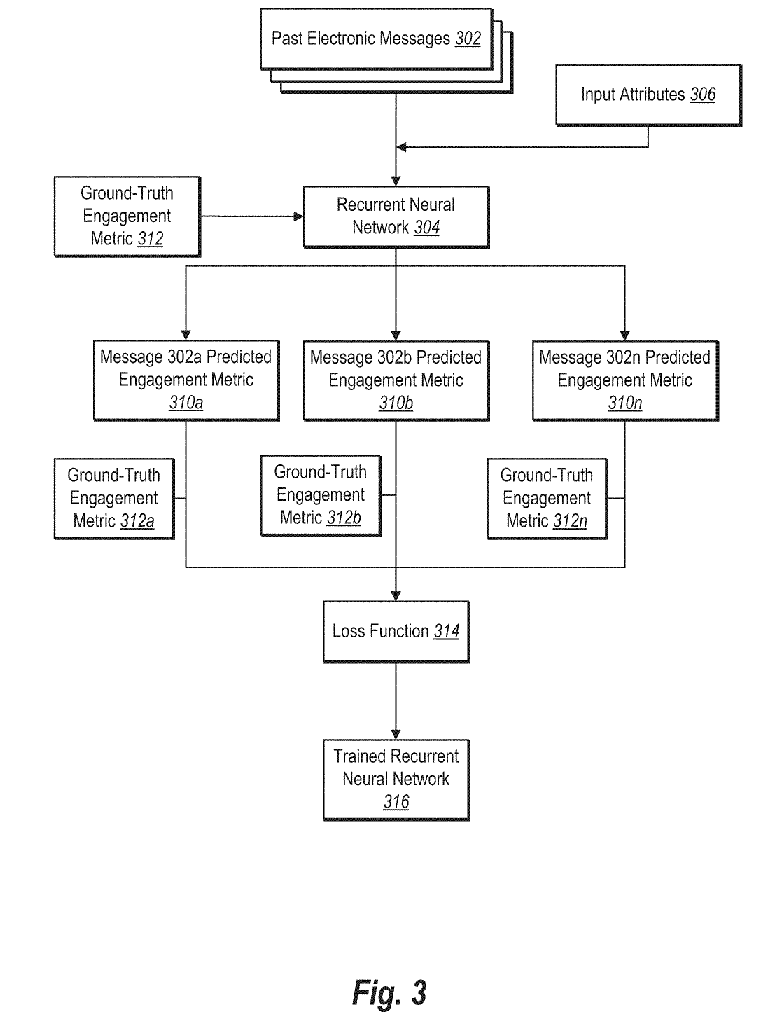

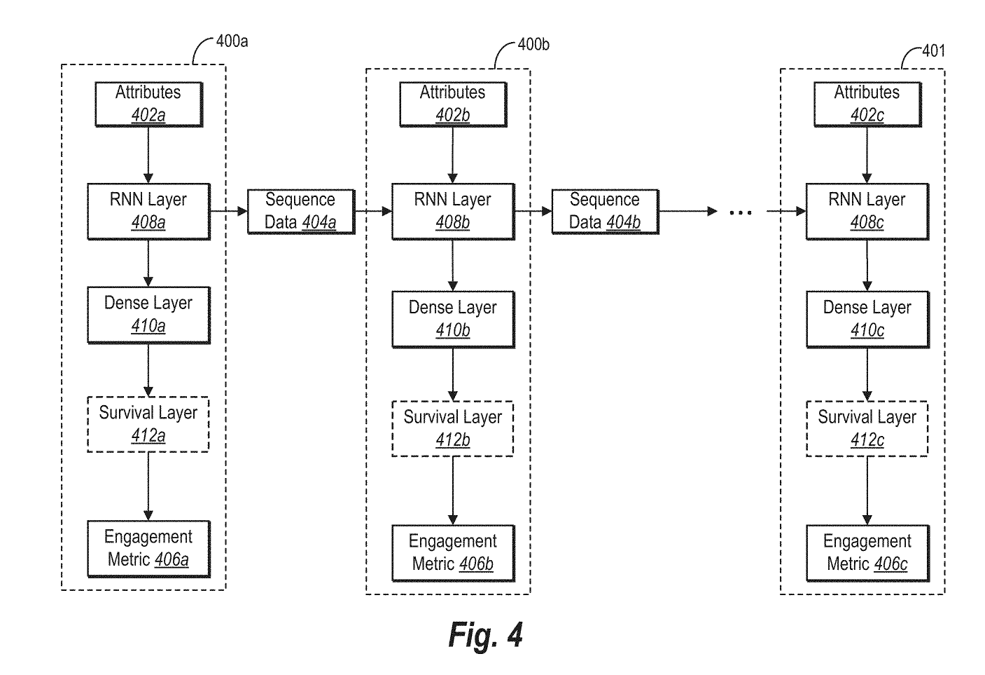

As shown in FIG. 2, in addition to the act 206, the campaign management system 102 also performs a step 208 for utilizing a recurrent neural network and the past electronic messages for the user to determine a time bin of the plurality of time bins for sending a new electronic message for the user. As shown, the step 208 includes the acts 212, 214 (including 214a or 214b), 216, and 218. Additional detail regarding acts in the step 208 also described below with regard to FIG. 2 (additional detail is also provided regarding such acts in relation to FIGS. 3 and 4).

As shown in FIG. 2, the step 208 can include the act 212. In particular, after determining the campaign parameters (and type of engagement metric), the campaign management system 102 performs an act 212 of training the recurrent neural network using the past electronic messages of a user (and/or the other users). For example, the campaign management system 102 can train the recurrent neural network for the user based on the past electronic messages for the user and/or the other users (e.g., as described in more detail in FIG. 3 below). To illustrate, the campaign management system 102 identifies electronic messages that have previously been sent to the user (and/or other users), and the campaign management system 102 trains the recurrent neural network to output the selected engagement metric based on the past electronic messages sent to the user (and/or other users).

In training the recurrent neural network, the campaign management system 102 also identifies various input attributes of the past electronic messages for the user. The input attributes can include information describing the past electronic messages, user behavior, and/or interactions with the past electronic messages by the user. For example, the campaign management system 102 can collect and provide input attributes to the recurrent neural network for each past electronic message. The input attributes can include information indicating responses by the user to messages sent prior to a currently analyzed message (e.g., open/click status and/or open/click times), most recent purchase behavior for the user, and transmission times of the messages (e.g., based on the time bin in which a message is partitioned). The input attributes can also include information obtained from other sources, such as postal databases, loyalty card databases, purchase databases, etc.

Using the input attributes, the campaign management system 102 trains the recurrent neural network to determine the engagement metric. In particular, the campaign management system 102 can train the recurrent neural network to identify significant features (e.g., weighted parameters) for determining the engagement metric. For example, for a hazard metric, the recurrent neural network automatically determines features by predicting a hazard metric for a prior electronic document and then comparing the predicted hazard metric with a ground truth metric. The recurrent neural network can then modify features (e.g., weighted parameters) to reduce loss between the predicted hazard metric and the ground truth metric. Alternatively, for an interaction probability metric, the recurrent neural network determines features by predicting an interaction probability metric for a prior electronic document and then comparing the predicted probability metric with a ground truth metric. The recurrent neural network can then modify features to reduce loss between the predicted probability metric and the ground truth metric.

As described in more detail below with respect to FIG. 4, the campaign management system 102 can utilize recurrent neural networks having a different structure based on whether the recurrent neural network is utilizing a hazard metric or an interaction probability metric. Specifically, the campaign management system 102 can utilize a recurrent neural network with a survival layer that utilizes a survival algorithm when generating a hazard metric. The campaign management system 102 can omit a survival layer when generating an interaction probability metric. Additionally, the campaign management system 102 can use different activation functions within the recurrent neural network when generating different engagement metrics.

After training the recurrent neural network using past electronic messages, the campaign management system 102 can perform the act 214 of utilizing the recurrent neural network to generate engagement metrics for a new electronic message for the user. Specifically, the campaign management system 102 determines input attributes for the new electronic message (similar to the input attributes described above).

Additionally, the campaign management system 102 determines a planning window for the new electronic message. As described in connection with FIG. 2, the planning window indicates a time window for executing the digital content campaign. Accordingly, the campaign management system 102 can determine the planning window to identify possible dates and times for transmitting the new electronic message. As mentioned, the analysis window (for grouping past electronic messages in training the recurrent neural network) can correspond to the planning window.

In connection with determining the planning window, the campaign management system 102 can determine time bins for the planning window. In one or more embodiments, the campaign management system 102 can identify time bins from the analysis window that also fall within the planning window. For example, if the analysis window includes 100 time bins of past electronic messages, the campaign management system 102 can divide the planning window into the same 100 time bins. Additionally, the time ranges associated with the time bins in the planning window can correspond to the time ranges associated with the time bins in the analysis window.

Furthermore, in one or more embodiments, the campaign management system 102 utilizes the trained recurrent neural network to analyze input attributes for the new electronic message and generate predicted engagement metrics for the new electronic message. As shown in FIG. 2, if the selected engagement metric type is a hazard metric, the campaign management system 102 can perform the act 214a of utilizing the recurrent neural network to generate hazard metrics for the time bins for the new electronic message. In particular, the campaign management system 102 can use the recurrent neural network to determine hazard metrics for the new electronic message for each time bin generated at the act 204. By generating a separate time-to interact metric for each time bin, the campaign management system 102 can model the user's time-to-interact with the electronic message if the electronic message was sent within each time bin. In this manner, the campaign management system 102 can score each time bin for the new electronic message, where the scores indicate the predicted time-to-interact if the new electronic message were sent to the user within the time bins.

Alternatively, if the selected engagement metric is an interaction probability metric, the campaign management system 102 performs the act 214b of utilizing the recurrent neural network to generate interaction probability metrics for the time bins. In particular, the campaign management system 102 can use the recurrent neural network determine interaction probability interaction metrics for the new electronic message for each time bin generated at the act 204. By generating a separate probability interaction metric for each time bin, the campaign management system 102 can model the user's probability of interacting with the electronic message if the electronic message was sent within each time bin. In this manner, the campaign management system 102 can score each time bin for the new electronic message, where the scores indicate the probability of interaction if the new electronic message were sent to the user within the time bins.

In each case, the campaign management system 102 can utilize the recurrent neural network to determine the engagement metrics for sending the new message within the time bins based on past user interactions with past messages. Moreover, as outlined in greater detail below (e.g., in relation to FIG. 3), the campaign management system 102 can utilize the recurrent neural network to sequentially analyze prior electronic messages in generating an engagement metric for a new electronic message. Thus, via the recurrent neural network, the campaign management system 102 can consider timing and sequential features of past electronic messages in determining a transmission time for a new electronic message.

Upon generating the engagement metrics (i.e., the hazard metrics or interaction probability metrics) for the time bins, the campaign management system 102 can then utilize the engagement metrics for the time bins to determine a transmission time for the new electronic message. For example, the campaign management system 102 can determine a time bin for sending the new electronic message in a digital content campaign by performing the act 216 of ranking the time bins using the engagement metrics.

Specifically, the campaign management system 102 can perform the act 216 by comparing the engagement metrics for the time bins to identify the time bins with the best engagement metrics. For example, the campaign management system 102 can rank the time bins based on hazard metrics and then select one or more time bins that have the highest hazard metrics (or lowest time-to-open value). Alternatively, the campaign management system 102 can rank the time bins based on interaction probability metrics and then select one or more time bins that have the highest interaction probability metrics.

In one or more embodiments, after ranking the time bins, the campaign management system 102 then includes an act 218 of determining a time bin for sending a new electronic message using one or more of the campaign parameters. In particular, while the ranked time bins allow the campaign management system 102 to determine the best individual time bins for sending electronic messages, campaign parameters can include certain constraints for sending messages in a campaign. The campaign management system 102 can select a time bin for each of the messages in the campaign to send to the user using the rankings of the time bins and within the constraints established by the campaign parameters.

For example, in one or more embodiments, the campaign parameters indicate a maximum number of messages to send as part of the campaign. The campaign management system 102 can therefore use the maximum number of messages to determine how many time bins to select. To illustrate, if the maximum number of messages is five for the campaign, the campaign management system 102 selects no more than five time bins after ranking the time bins. While the maximum number of messages can place an upper limit on the number of messages for a user, the campaign management system 102 may send fewer than the maximum number, depending on the user's preferences (e.g., a user preference in a user profile indicating a number of messages that the user wishes to receive, or time periods in which the user does not wish to receive messages) or based on one or more predicted engagement metrics not meeting a predetermined threshold. Thus, the campaign management system 102 can tailor the number of messages for a user to produce the best results for that user.

Additionally, the campaign parameters can indicate a frequency parameter for sending messages in the campaign. In particular, the frequency parameter indicates a number of messages that the campaign management system 102 can send to the user within a specific time window. For instance, the frequency parameter can limit the campaign management system 102 to sending no more than one message per day to a user. If the campaign management system 102 determines that more than one time bin in a single day is ranked within the top N number of time bins (where N corresponds to the maximum number of messages for the campaign), the campaign management system 102 can skip the lower ranked time bin on that day. Thus, the campaign management system 102 can select N−1 time bins for sending messages instead of N time bins. Alternatively, the campaign management system may select a next-highest ranked time bin (i.e., the next highest ranked time bin).

In one or more embodiments, the campaign management system 102 also determines whether each time bin meets a predetermined engagement threshold value. For example, the campaign management system 102 can set a predetermined engagement threshold value that indicates a maximum or minimum value (based on the corresponding engagement metric) for a time bin. If a time bin satisfies the predetermined threshold (e.g., the engagement metric that the recurrent neural network generates for that time bin satisfies the threshold), the time bin is eligible to be selected; otherwise, the time bin is excluded from selection.

Upon determining the time bin for sending a new electronic message, the campaign management system 102 can perform the act 210 of sending the new electronic message based on the determined time bin. In one or more embodiments, the campaign management system 102 selects a time that falls within the time bin for sending the electronic message. For example, the campaign management system 102 can select a transmission time at the beginning of a time bin, at the end of the time bin, or at some other time within a time bin. For instance, in one or more embodiments, the campaign management system 102 selects a transmission time based on past electronic messages within the time bin. To illustrate, the campaign management system 102 can average the timestamps for past electronic messages within the time bin to determine the transmission time for the electronic message and then execute the campaign by sending the new electronic message at the send time. In yet other embodiments, the campaign management system 102 can select a transmission time within a time bin based on available network and/or computer processing power within the time bin. For example, the campaign management system 102 can queue the electronic message to be sent at a time within the time bin that reduces computer processing power (e.g., at a time when there is a minimum amount of other messages being sent or at a time that avoids spikes within the time bin).

The acts 202-218 described in relation to FIG. 2 are intended to be illustrative of an exemplary sequence of acts in accordance with the present disclosure, and are not intended to limit potential embodiments. Alternative embodiments can include additional, fewer, or different acts than those articulated in FIG. 2. For instance, although the description above references a single new electronic message, the campaign management system 102 can select time bins for a plurality of new messages. Indeed, the campaign management system 102 can utilize the approach described above to select five transmission times (e.g., five time bins) for five new messages. In particular, the campaign management system 102 can identify the five time bins corresponding to the five highest engagement metrics (subject to constraints) and then send one of the five new messages within each of the five time bins.

In one or more alternative embodiments, rather than determining the length of the analysis window and the length of the planning window to be the same, the campaign management system 102 can determine the length of the analysis window to be different than the length of the planning window. Specifically, the campaign management system 102 can use an analysis window that includes a lesser or greater time range and fewer or more time bins than the planning window includes. Accordingly, the campaign management system 102 can train a recurrent neural network for a user based on a plurality of past electronic messages for the user within a time range that is different than the time range of the planning window.

For example, the campaign management system 102 can train the recurrent neural network using an analysis window of one month that includes 100 time bins. The campaign management system 102 can then utilize the recurrent neural network for a campaign with a planning window of two weeks. The campaign management system 102 can analyze a subset of the 100 time bins from the analysis window (e.g., the subset of 50 time bins from the first two weeks of the analysis window that overlap the two week planning window). Based on the analysis of the subset of time bins, the campaign management system 102 can select a send time for one or more new messages. Accordingly, the campaign management system 102 can train the recurrent neural network with electronic messages from an analysis window that reflects a longer time period than a planning window.

Additionally, the acts described herein may be performed in a different order, may be repeated or performed in parallel with one another, or may be performed in parallel with different instances of the same or similar acts. For example, in one or more embodiments, rather than obtaining an engagement metric and campaign parameters from an administrator prior to training the recurrent neural network, the campaign management system 102 can obtain one or both after training the recurrent neural network for determining send times for new electronic messages. For instance, the campaign management system 102 can include a recurrent neural network for each possible engagement metric and then use the recurrent neural networks to output more than one prediction for a new message. The campaign management system 102 can then use the applicable output from the recurrent neural networks to determine the send times for messages based on a selected engagement metric. The models that include the recurrent neural networks can include a different structure for each of the engagement metrics, as described in more detail with respect to FIG. 4. Furthermore, as described below, the campaign management system 102 can use campaign parameters to determine a schedule of send times for the campaign after training the recurrent neural networks.

Additionally, in one or more embodiments, the campaign management system 102 trains and/or utilizes a recurrent neural network for a plurality of users, rather than for an individual user. In particular, the campaign management system 102 can determine a target audience (e.g., based on input from a campaign administrator selecting the target audience) and use past electronic messages for the target audience (or a subset of the target audience) to train the recurrent neural network. The campaign management system 102 can then utilize the recurrent neural network to output an engagement metric for sending a new electronic message to a single user or the plurality of users in the target audience within one or more time bins.

As described above, the step 208 includes training a recurrent neural network for a user based on past electronic messages for the user (and other users). FIG. 3 illustrates a schematic diagram of training a recurrent neural network based on past electronic messages for a user (and/or other users). Specifically, training a recurrent neural network first includes inputting a plurality of past electronic messages 302 (e.g., emails) into the recurrent neural network 304. For instance, the campaign management system 102 selects a plurality of past electronic messages that the campaign management system 102 has sent to the user in connection with one or more previous digital content campaigns. As previously mentioned, the campaign management system 102 partitions the past electronic messages 302 (together with past electronic messages for other users) into time bins.

In addition, as shown in FIG. 3, the campaign management system 102 provides input attributes 306 associated with the past electronic messages 302 as input to the recurrent neural network 304. The input attributes 306 can include available information regarding the past electronic messages. For example, the input attributes 306 can include information regarding responses to the past electronic messages 302. For example, the input attributes 306 can include information associated with electronic messages chronologically prior to a given electronic message such as, but not limited to, the last message opened, the last message selected, whether the last message was mass emailed (e.g., sent to seventy-five percent of users for messages in the training period), days since the last message was sent, days since the last purchase by the user, binary indicators for whether the user made a web (i.e., online) purchase since the last message or whether the user made an offline purchase, non-electronic messages sent since the last message, etc. The input attributes 306 can also include a send time or time bin of the given message (e.g., based on the timestamp of the given message).

Furthermore, the campaign management system 102 also provides a ground-truth engagement metric 312 as an input to the recurrent neural network. In particular, the ground-truth engagement metric 312 can include a ground truth hazard metric, such as the actual time between transmission time of a past electronic message and interaction by the user. Similarly, the ground-truth engagement metric 312 can include ground-truth interaction probability metric, such as a binary indicator of whether or not a user actually interacted with a past electronic message. The campaign management system 102 can compare predicted engagement metrics with the ground-truth engagement metric 312 to generate a trained recurrent neural network 316.

Indeed, as illustrated, during training the recurrent neural network 304 analyzes input attributes of each of the past electronic messages 302 and generates a predicted engagement metrics 310a-310c. In particular, the recurrent neural network 304 analyzes different features of the past electronic messages at different levels of abstraction utilizing different layers of the recurrent neural network 304. For example, the recurrent neural network can utilize various layers (discussed in greater detail in FIG. 4) to generate weighted parameters to predict engagement metrics for each message.

For example, the recurrent neural network 304 generates a first predicted engagement metric 310a for a first message 302a of the past electronic messages 302 using input attributes 306 corresponding to the first message 302a. The recurrent neural network 304 also generates a second predicted engagement metric 310b for a second message 302b of the past electronic messages 302 using input attributes 306 corresponding to the second message 302b. The recurrent neural network 304 continues analyzing the past electronic messages 302 and generating predictions for each message until generating an Nth predicted engagement metric 310n for a message 302n of the past electronic messages 302 using input attributes 306 corresponding to the message 302n.

As shown, upon generating a predicted engagement metric for a message, the campaign management system 102 can compare the predicted engagement metric to a ground-truth engagement metric. For example, the campaign management system 102 can compare the first predicted engagement metric 310a to a ground truth engagement metric 312a, the second predicted engagement metric 310b to a second ground truth engagement metric 312b, etc., and the Nth predicted engagement metric 310n to an Nth ground truth engagement metric 312n. The campaign management system 102 can thus compare each predicted engagement metric to the corresponding ground-truth engagement metric upon generating each predicted engagement metric.

As shown, the campaign management system 102 can compare predicted engagement metrics and ground truth engagement metrics utilizing a loss function 314. The loss function 314 can include a function that describes the difference of each of the prediction/ground truth pairs. For example, the predicted engagement metric 310a can include a predicted hazard metric of 10 minutes and a ground-truth hazard metric of 15 minutes. The campaign management system 102 can compare the predicted hazard metric and the ground-truth hazard metric utilizing the loss function 314 to determine a measure of error (e.g., 5 minutes).

In addition, as shown, the campaign management system 102 can use the loss function 314 to generate the trained recurrent neural network 316. In particular, the campaign management system 102 can modify one or more weights (e.g., weights for parameters) of the recurrent neural network 304 to reduce the differences between the predicted engagement metrics 310a-310n and the ground truth engagement metrics 312a-312n. For example, in one or more embodiments, the campaign management system 102 utilizes a binary cross-entropy algorithm as a loss function. Moreover, the campaign management system 102 utilizes a stochastic gradient descent as an optimizer to reduce the measure of loss for each prediction. Similarly, in other embodiments, the campaign management system 102 utilizes a negative log partial likelihood function with Efron's approximation as the loss function. In another example, the campaign management system 102 utilizes a survival loss function (i.e., a loss function based on a hazard metric generated by a survival function). By modifying the recurrent neural network 304 to reduce the measure of loss, the campaign management system 102 creates a trained recurrent neural network 316 that is capable of generating predictions of engagement metrics for new electronic messages to be sent to the user.

Turning now to FIG. 4, additional detail will be provided regarding an exemplary architecture of a recurrent neural network in accordance with one or more embodiments. In addition, additional detail is provided regarding utilizing a trained neural network to generate an engagement metric for one or more new messages. For example, FIG. 4 illustrates utilizing a recurrent neural network architecture trained based on past electronic messages to generate an engagement metric for one or more new messages.

As illustrated in FIG. 4, the campaign management system 102 processes a plurality of past electronic messages in a plurality of stages 400a-400b according to a sequential order (e.g., chronological order) of the electronic messages. Each stage utilizes a recurrent neural network with a plurality of layers that allow the campaign management system 102 to generate predictions for each of the past electronic messages and then compare the predictions against ground-truth values to train the recurrent neural network. Furthermore, the structure of the stages 400a-400b is based on the type of engagement metric to be output by the stages 400a-400b. More specifically, the stages 400a-400b use survival analysis for generating hazard metrics but do not use survival analysis for generating interaction probability metrics.

In one or more embodiments, the campaign management system 102 uses information derived from the past electronic messages for the user (and/or other users) as an input to the recurrent neural network for analyzing the past electronic messages and training the recurrent neural network. In particular, the campaign management system uses attributes 402a associated with the past electronic messages as an input to a first stage of the process (e.g., for a first message in the sequence of past messages). For example, the campaign management system 102 can determine a feature vector that represents features of a plurality of past electronic messages for the user. To illustrate, the feature vector can include an elementwise average of the feature vectors of the most recent messages (e.g., prior to the first message in the sequence of past electronic messages or prior to the new electronic message) to create a single vector that describes the average number of messages opened, selected, or with which the user has otherwise interacted, etc., as previously described. Thus, the feature vector can represent a recency effect of past interactions by the user, and the campaign management system 102 can vary the number of most recent messages to vary the recency effect.

In each subsequent stage in the training process (e.g., stage 400b), the campaign management system 102 can input attributes associated with the corresponding message into the recurrent neural network. As previously described, the input attributes indicate user interactions or send characteristics associated with current message and/or previous messages, as well as the time bin for the current message. For instance, the attributes 402b for a second message in the sequence of past messages can include user interactions or send/transmission characteristics associated with the first message and the time bin of the second message. Thus, the attributes 402b for the second stage 400b can reflect the user interactions with the past messages (especially the first message) sequentially prior to the second message.

Furthermore, as the campaign management system 102 processes each message in separate stages, the campaign management system 102 can determine data that the recurrent neural network determines is important for predicting the engagement metrics according to a sequential order of the messages in the campaign. In particular, FIG. 4 illustrates that each stage 400a-400b passes sequence data 404a-404b to the next stage for use in analyzing the next sequential message. The sequence data can include internal parameters or other significant features that the recurrent neural network determined in predicting engagement metrics for the messages. For example, after analyzing the first message of the past messages for the user in the first stage 400a, the first stage 400a passes sequence data 404a to the second stage 400b for analyzing the second message of the past messages for the user. Similarly, the second stage 400b can pass sequence data 404b that is based on the second stage 400b and the first stage 400a to the third stage 401 for predicting engagement metrics for the new electronic message. Thus, the recurrent neural network captures data corresponding to the sequential order of the messages for use in predicting user interactions with each new message.

As mentioned, the campaign management system 102 uses the recurrent neural network to generate predictions for each past message when training the recurrent neural network. Specifically, each stage 400a-400b outputs a predicted engagement metric 406a-406b for the corresponding message. To illustrate, the first stage 400a analyzes the first message and outputs an engagement metric 406a for the first message. Similarly, the second stage 400b analyzes the second message and outputs an engagement metric 406b for the second message.

To generate an engagement metric, each of the plurality of stages 400a-400b include a recurrent neural network layer (“RNN Layer”) 408a-408b and a dense layer 410a-410b. The RNN layers 408a-408b include the recurrent neural network that receives input attributes and/or other data associated with a currently analyzed electronic message and past electronic messages for informing the output of the RNN layers 408a-408b. For example, as previously described, the RNN layer 408a of the first stage 400a can receive attributes 402a corresponding to the first message and then output sequence data 404a to the second stage 400b. The RNN layer 408b of the second stage 400b can receive attributes 402b corresponding to the second message and sequence data 404a from the first stage 400a and then outputs sequence data 404b to a subsequent stage (not shown).

The RNN layers 408a-408b can include a variety of nodes to process arbitrary sequences of inputs (e.g., arbitrary sequences of electronic messages). For instance, the RNN layers 408a-408b may include a series of fully connected layers or nodes for processing a sequence of electronic messages and outputting engagement metrics for the messages. The RNN layers 408a-408b output data to the dense layers 410a-410b for additional processing of the data.

In one or more embodiments, the dense layers 410a-410b include fully connected layers including activation functions at the output of the RNN layers 408a-408b. For example, the campaign management system 102 can use a classification model that generates an interaction probability metric at each stage 400a-400b. Specifically, in the classification model, the dense layers 410a-410b can include a sigmoid activation function at the output of the RNN layers 408a-408b, which then produce interaction probability metrics for the corresponding past electronic messages. To illustrate, for a given stage (e.g., stage 400a), the RNN layer 408a and the dense layer 410a output an interaction probability metric (e.g., a probability for classifying the message as being interacted with, or not) for the first message of the past electronic messages for the user.

Alternatively, the campaign management system 102 can use a survival model that generates a hazard metric at each stage 400a-400b. In particular, in the survival model, the dense layers 410a-410c can include an exponential activation function at the output of the RNN layers 408a-408c, and survival layers 412a-412c are connected to the outputs of the dense layers 410a-410c to produce hazard metrics for a plurality of time bins. To illustrate, for a given stage (e.g., stage 400a), the RNN layer 408a, the dense layer 410a, and the survival layer 412a output a hazard metric for each of the plurality of time bins.

At each stage, the campaign management system 102 then uses the engagement metrics 406a-406b to train the recurrent neural network to reduce error in the predictions. Specifically, the engagement metrics can compare the engagement metrics 406a-406b to the corresponding ground-truth actual values for the past messages. For instance, the campaign management system 102 can compare the engagement metric 406a to the ground-truth actual value for the first message (e.g., from user interaction data associated with the first message) to update the RNN layer 408a in the first stage 400a. Likewise, the campaign management system 102 can compare the engagement metric 406b to the ground-truth actual value for the second message to update the RNN layer 408b in the second stage 400b.

While FIG. 4 illustrates only two stages 400a-400b for training the recurrent neural network on past electronic messages, the campaign management system 102 can use more stages for training the recurrent neural network. For example, the recurrent neural network can include a stage for each past electronic message for the user within the analysis window. Accordingly, if the analysis window includes fifty past electronic messages for the user partitioned into a plurality of time bins, the recurrent neural network can include fifty stages—one for each past electronic message for the user. Furthermore, the stages are ordered to analyze the past electronic messages according to a sequential order of the past electronic messages (e.g., the most recent past electronic message corresponding to a final stage of the training stages and the oldest past electronic message corresponding to a first stage of the training stages).

As mentioned, the campaign management system 102 can train the model including the recurrent neural network based on past electronic messages for a user and use the trained network to analyze new electronic messages. For instance, as shown in FIG. 4 the campaign management system 102 then utilizes the trained neural network resulting from the plurality of stages 400a-400b to generate predictions for a new electronic message for the user. In particular, the campaign management system 102 includes a stage 401 that follows the sequential order of the past electronic messages (e.g., occurs chronologically after a most recent past electronic message). The stage 401 utilizes the trained recurrent neural network with a structure that corresponds to the type of engagement metric that the stage 401 outputs. Specifically, for generating an interaction probability metric, the stage 401 includes an RNN layer 408c and a fully connected dense layer 410c including a sigmoid activation function at the output of the RNN layer 408c. For generating a hazard metric, the stage 401 includes an RNN layer 408c, a fully connected dense layer 410c including an exponential activation function at the output of the RNN layer 408c, and a survival layer 412c connected to the outputs of the dense layer 410c.

To predict an engagement metric 406c for a new electronic message, the stage 401 receives, as input to the RNN layer 408c, attributes 402c corresponding to the new electronic message and sequence data from a final stage of the training process. In particular, the attributes 402c include information describing a plurality of past electronic messages for the user (e.g., user interactions and transmission characteristics, as described previously). Additionally, a stage immediately prior to stage 401 (e.g., a final stage in the training process for a most recent past electronic message in the training dataset) passes on sequence data that the recurrent neural network has learned during the training process.

The stage 401 uses the attributes 402c and the sequence data to generate the engagement metric 406c for the new electronic message and for a time bin. For instance, the campaign management system 102 varies the time bin for the new electronic message according to a plurality of time bins within a planning window to predict a plurality of engagement metrics 406c for the plurality of time bins. Thus, the campaign management system 102 generates a separate engagement metric 406c for each time bin to obtain a plurality of engagement metrics 406c for the plurality of time bins within the planning window.

As also mentioned previously, each stage of the model of FIG. 4 generates an engagement metric for each of the time bins. Using the engagement metrics, the campaign management system 102 determines a send time for an electronic message by ranking the time bins. In particular, the campaign management system 102 can rank the time bins to select the time bin with the best engagement metric (e.g., maximum interaction probability metric or minimum hazard metric). The campaign management system 102 can also determine a send time associated with the selected time bin for sending the electronic message during the determined send time. For sending a plurality of electronic messages, the campaign management system 102 can also use one or more campaign parameters (e.g., message frequency) for determining which time bins to select.

After sending the electronic message at a time corresponding to a time bin based on the engagement metric 406c, the campaign management system 102 can track user interactions with the electronic message. For example, the campaign management system 102 can determine whether and/or when the user opens the message, selects content within the message, follows a link within the message to an external site, completes a purchase as a result of the message, etc. The campaign management system 102 can leverage the user interaction information with the message to update the recurrent neural network by comparing a ground-truth actual value for the message to the engagement metric 406c to determine a loss and then updating one or more algorithms of the recurrent neural network accordingly.

The campaign management system 102 can also be described in terms of particular variables, equations, and or pseudo-code for determining transmission times utilizing one or more computer devices. Accordingly, additional detail will now be provided regarding one or more of these exemplary embodiments.

For a user c and the history of past messages sent to the user denoted as (M₁, M₂, . . . , Mₖ₋₁}. Each Mᵢ, i∈{1, . . . , k−1} has a set of features, denoted by Xᵢ, for the ith message. The feature set includes the input attributes as previously described relative to FIG. 3 (e.g., user interactions and send characteristics). For instance, a user interaction with message Mᵢ is denoted by {Yᵢ, Tᵢ, δᵢ}, where Yᵢ is a binary indicator of whether the message being analyzed was opened and Tᵢ is the time difference between send time and open time. δᵢ is a binary indicator of whether the open event is censored (i.e., if the open event is not observed within a certain time period Cᵢ. In a case of censoring (i.e., δᵢ=1), Yᵢ=0 and Tᵢ=Cᵢ.

Furthermore, as mentioned, the time bin for sending an electronic message is one of the features in Xᵢ. For example, in the present embodiment, the time bin is one of 100 possible time bins within the planning window. Additionally, the time bin may be encoded using a one-hot vector of length 100. The number of time bins may vary based on the planning window length and the scheduling precision, as determined by the campaign management system 102.

The campaign management system 102 uses the recurrent neural network to determine the optimal send time kth message onwards. For each message, the campaign management system 102 scores the time bins using the interaction probability metric or the hazard metric for the message (i.e., when the message is sent during the scored time bin). Because the time bin is one of the input attributes for a message, varying the time bin obtains different scores for each bin. The two types of scoring models (i.e., classification and survival) optimize for different administrator-specified objectives. Both models use a recurrent neural network, which helps to model the sequential interaction data associated with a plurality of messages.

For the classification model, the campaign management system predicts whether a customer will interact with the kth message. Specifically, input to the classification model includes the feature vectors of the historical sequence of past messages sent to the user. The campaign management system restricts the length of the sequence to m messages in the past. Consequently, the input to the model is characterized as {Xₖ₋ₘ₊ᵢ, Xₖ₋ₘ₊₂, . . . , Xₖ}, and the expected output for the sequence is Yₖ. Generalized, the output is Y_{c,k+1,b} for the cth user, the (k+1)th message, and the bth bin.

The campaign management system 102 first passes the input sequence through a recurrent neural network layer one message at a time, followed by a fully connected layer with sigmoid activation function. At each step, the campaign management system 102 optimizes the model to predict Y₁ for that message. Furthermore, the classification model can use stochastic gradient descent as an optimizer with binary cross-entropy as the loss function.

In alternative embodiments involving a survival model, the campaign management system predicts an interaction time for a message. Specifically, the survival model of the present embodiment predicts an open time for a message. In one example, the campaign management system 102 uses a proportional hazards framework for modeling the process of predicting the time-to-interact of a message. For each message, the campaign management system 102 can compute a hazard ratio, which is the time-independent component of a hazard rate and only depends on the input attributes. The hazard rate represents the instantaneous probability of the user opening the message given it has not been opened till now. The higher the hazard ratio, the higher the instantaneous risk of occurrence of opening the message. Generalized, the survival model outputs a hazard rate h(t), for (i, k+1, b).

The campaign management system 102 first passes the input sequence through a recurrent neural network one message at a time, followed by a fully connected layer with exponential activation function (as described in relation to FIG. 40. The campaign management system 102 can also use a negative log partial likelihood function with Efron's approximation as the loss function. Efron's approximation changes the likelihood function to account for data points with tied time-to-open values. The output layer predicts that hazard ratio, Ψ(Xᵢ), for each message. The survival function has access to the actual value {Tᵢ, δᵢ} on which the campaign management system 102 calculates the loss.

Once the campaign management system 102 has generated the engagement metrics for a plurality of time bins for a message, the campaign management system 102 ranks the time bins and selects a time bin for the message. To illustrate, for a classification model, the campaign management system 102 sorts the time bins based on the corresponding interaction probability metrics. For a survival model, the campaign management system 102 sorts the time bins based on the corresponding hazard ratios.

Because campaign administrators typically plan for a plurality of messages within a campaign, the administrator may request to generate a send schedule for all of the messages in the campaign. Accordingly, the selected time bin for one or more of the messages may change depending on the total number of messages and limits on the frequency of messages to send. Thus, given the number of messages to be sent for a campaign within a planning window, the campaign management system 102 determines the optimal send time for each message such that the total sum of scores for the time bins is maximized (or minimized, depending on the type of scoring/metrics) subject to constraints such as total volume and frequency of messages.

For example, the campaign management system 102 can sort the time bins according to the scores for the corresponding engagement metric. To illustrate, the campaign management system 102 can select a plurality of time bins equal to the total number of messages in the campaign. The campaign management system 102 can also filter out time bins violating the frequency constraint. Thus, if any of the selected time bins violates the frequency constraint (e.g., by being too near another time bin), the campaign management system 102 can remove or skip over the selected time bin. The campaign management system 102 can generate a schedule for sending the plurality of messages using the selected time bins that meet the maximum message and frequency constraints.

Furthermore, as previously mentioned briefly, when scheduling a plurality of messages to be sent, the campaign management system may not have input attributes for the future messages within the planning window. To overcome this deficiency, the campaign management system 102 can make a simplifying assumption by constructing input attributes for each future message at the planning window (e.g., using the input attributes for past electronic messages). The campaign management system 102 can then assume that these input attributes remain constant throughout the planning window (i.e., as an input for each stage of the model).

To determine the benefits provided by the campaign management system 102, researchers have also performed research based on one or more experimental embodiments. In particular, in one experimental embodiment, an initial dataset included user interactions by approximately 1.2 million users with emails in a campaign by an e-retail company over a period of 2 years (December 2013 to December 2015). In addition to email tracking information (e.g., user interaction information), the dataset included customer purchase dates, purchase frequency, nature of the transactions (online or offline), email open rates, email click/selection rates, postal features, etc.

In this experimental embodiment, the campaign management system 102 considered only data from December 2013 to April 2014 for evaluating the models. Users receiving less than two messages within the five-month period were excluded. Additionally, the evaluation kept only the users who had either received more than ten messages or had been receiving messages from the company at least once every thirty days. This allowed the campaign management system 102 to have sufficient data for modeling the users' interactions. Additionally, the campaign management system 102 excluded transactional messages (identified as messages corresponding to campaigns sent to less than 400 recipients). Finally, messages with more than ten responses were removed because the responses were assumed to possibly include automated responses.

Thus, for the final dataset of the experimental embodiment, the number of recipient users was approximately 0.8 million, the number of messages was approximately 74.5 million, the number of unique campaigns was 2600, the percentage of emails opened was approximately 20.8%, and the percentage of clicks was approximately 2.3%. The campaign management system 102 randomly sampled 20,000 users and constructed features for the users. A maximum sequence length for the models is sixteen (i.e., only the last m=16 messages are considered for a user if available. Furthermore, the campaign management system 102 reported the results after performing 5-fold cross-validation on the randomly sampled subset of users.

For the classification models, the model including a recurrent neural network is compared against two other models—namely, logistic regression and feedforward neural network. Because logistic regression does not allow for explicitly taking sequential data as input, the evaluation used a feature-wise average of the feature vectors in the input sequence for the logistic regression. The actual output collected is whether the last message was opened. The evaluation used the same input and output formulation for the feedforward neural network. Table 1 below illustrates the performance for the three models in terms of area under a receiver operating characteristic curve (AUC) and F-measure. As illustrated in Table 1, the classification model using a recurrent neural network has the highest AUC and the second highest F-measure.

TABLE 1
Results for open probability models

| Model Name | AUC | F-Measure |
|---|---|---|
| Logistic Regression | 89.77 | 0.602 |
| Feedforward Neural Network | 89.89 | 0.627 |
| Recurrent Neural Network | 90.403 | 0.624 |

For the survival models, the model including a recurrent neural network is compared against two survival analysis models—namely, a Cox Proportional Hazard model (Cox-PH) and a Weibull Accelerated Failure Time model (Weibull AFT). Similar to the baseline classification models, the input attribute vector for the Cox-PH and Weibull AFT models is a feature-wise average of the feature vectors in the input sequence. Table 2 illustrates the performance for the three models in terms of a concordance index, which is a standard evaluation metric used in survival models. Specifically, the concordance index is a generalization of AUC to censored data and is defined as the fraction of comparable pairs of data points where the actual values and predicted order of time-to-open are the same. Comparable pairs are those in which at most one data point is censored. Table 2 indicates that the recurrent neural network model achieves the highest concordance index, which may be attributed to the use of recurrent neural networks for modeling sequential data.

TABLE 2
Results for time-to-open prediction models

| Model Name | Concordance Index |
|---|---|
| Cox-PH | 85.980 |
| Weibull AFT | 85.986 |
| Recurrent Neural Network | 86.911 |
| with Survival Loss | |

As described above, the campaign management system 102 provides improvements over conventional models. Specifically, the campaign management system 102 can provide highly accurate predictions of interaction probability and hazard metrics. Additionally, the campaign management system 102 provides the flexibility for obtaining multiple different metrics based on the selected engagement metric.

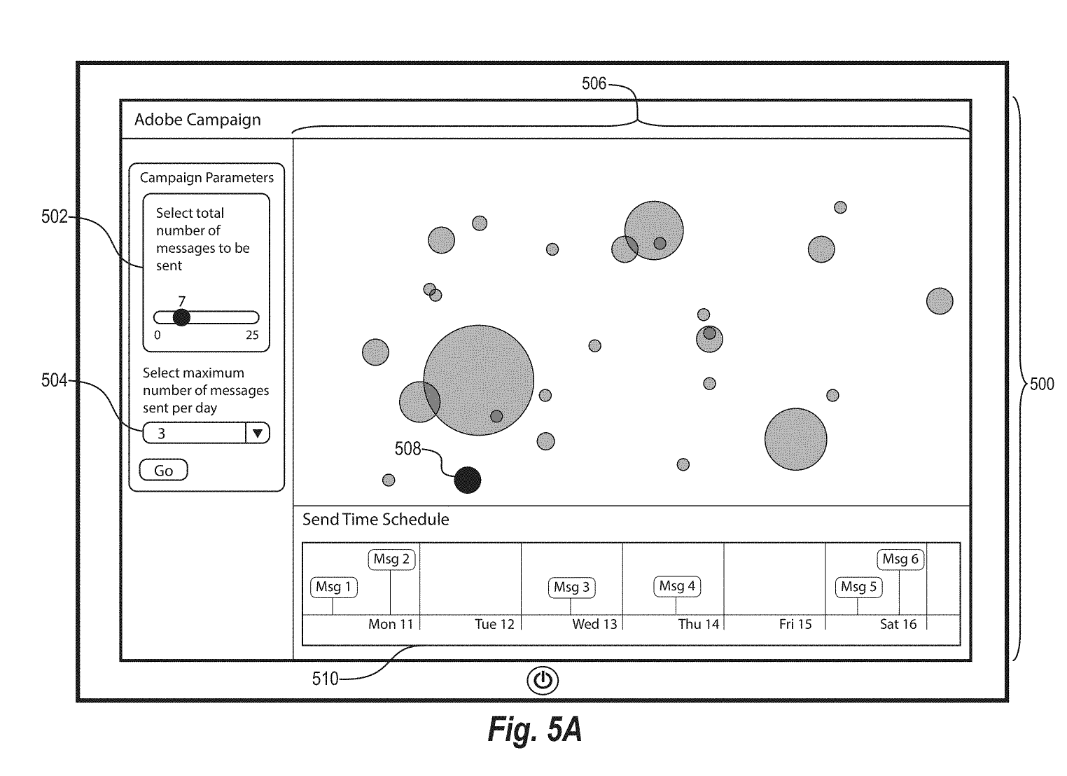

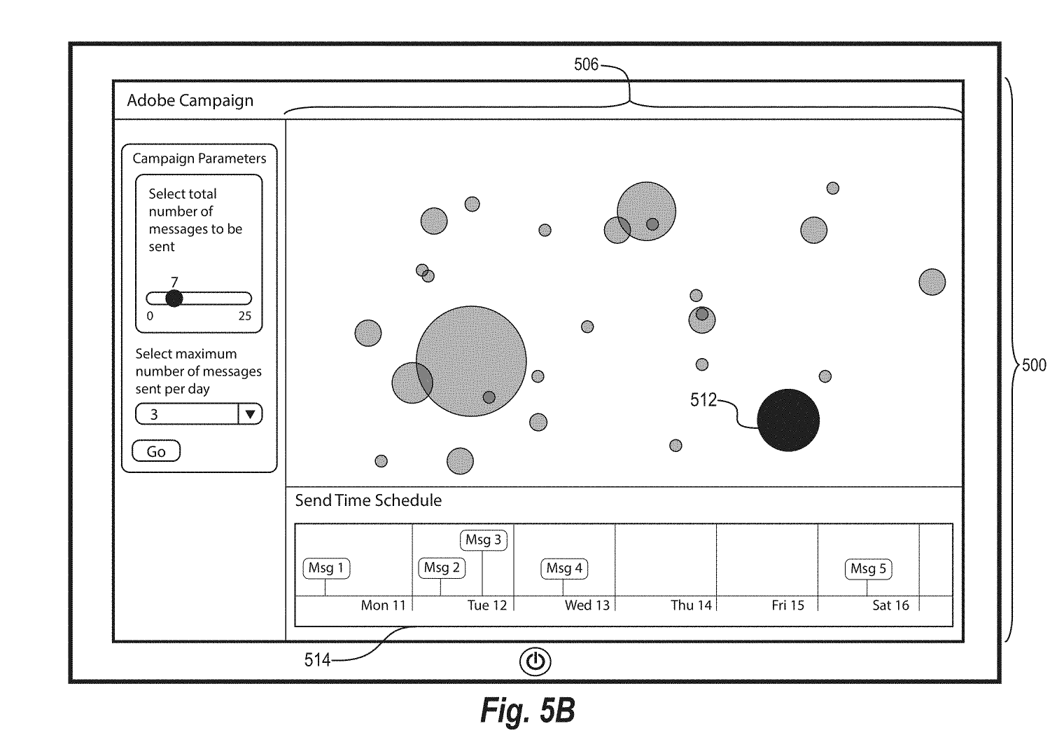

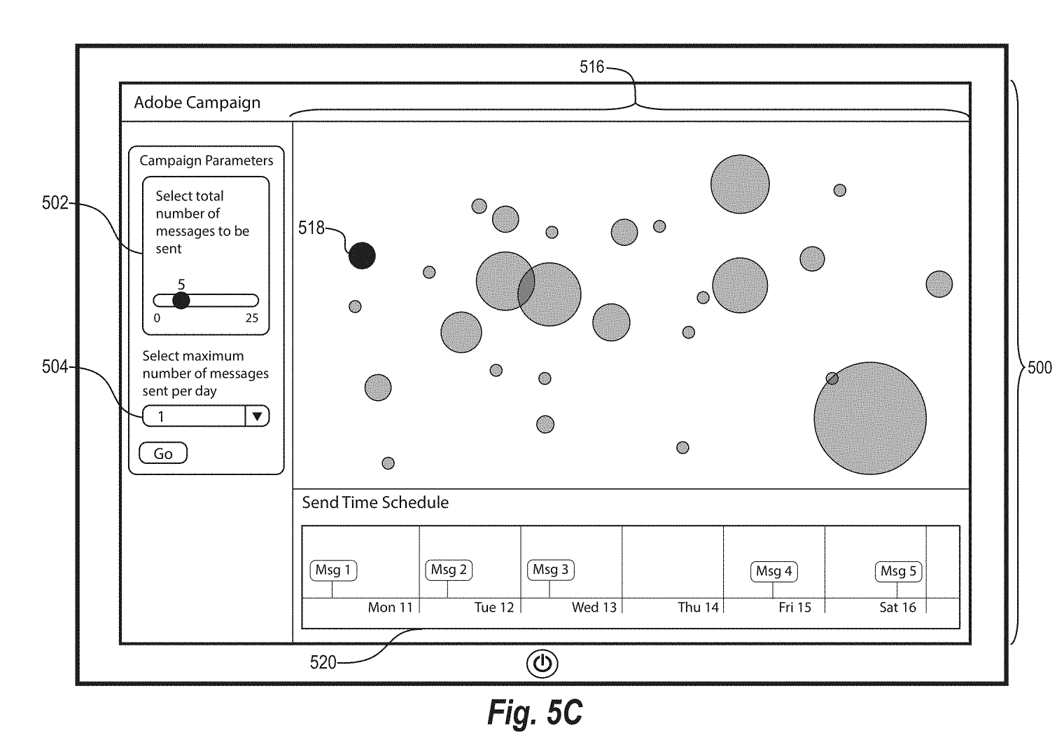

As mentioned above, the campaign management system 102 assist in planning and executing digital content campaigns. In particular, FIGS. 5A-5C illustrate graphical user interfaces generated by the campaign management system 102 in accordance with one or more embodiments for planning and executing strategic transmission times for electronic messages in a digital content campaign.

FIG. 5A illustrates an embodiment of a campaign management interface 500 by which an administrator of a digital content campaign can manage the campaign. Specifically, the campaign management interface 500 operates on an administrator client device (e.g., the administrator client device 104). Additionally, the campaign management interface 500 may be part of an administrator application (e.g., the administrator application 116) that allows the administrator to manage various aspects of the campaign, including transmitting electronic messages for the campaign and/or executing the campaign by sending the electronic messages to one or more users.

As illustrated, the campaign management interface 500 provides a plurality of options that allow the administrator to select one or more campaign parameters for the campaign. For instance, the campaign parameters can include a message number parameter 502 and a message frequency parameter 504. To illustrate, the message number parameter 502 indicates a total number of messages to send in connection with the campaign. FIG. 5A illustrates that the administrator has selected the total number of messages to be “7” for the campaign.

Additionally, the message frequency parameter 504 indicates the maximum number of messages sent in a given time period. For example, the message frequency parameter 504 can be for a day, week, or any other time period. FIG. 5A illustrates that the administrator has selected the maximum number of messages sent per day as three. Additionally, the time period may be modifiable, allowing the administrator to set the number of messages and the time period for the message frequency parameter 504. Thus, the campaign management interface 500 can provide a variety of customizability options for the administrator to use in executing the campaign.

Furthermore, while FIG. 5A illustrates the message number parameter 502 in connection with a slider bar and the message frequency parameter 504 in connection with a dropdown menu, the campaign management interface 500 can provide other methods of allowing the administrator to choose the campaign parameters. For instance, either or both the message number parameter 502 and the message frequency parameter 504 can be set using a slider bar, dropdown menu, input field, or other method of inputting a number value.

Additionally, the campaign management interface 500 may also include additional campaign parameters. For example, the campaign management interface 500 may include an option to set a planning window (or analysis window) of the campaign. To illustrate, the administrator may select a campaign start date and a campaign end date to establish the planning window for the campaign. As previously described, the campaign management system can use the planning window to determine an analysis window for partitioning past messages to train the recurrent neural network (or a plurality of recurrent neural networks) for a plurality of potential recipients.

Additionally, the campaign management interface 500 can include an engagement metric parameter that allows the administrator to select a type of engagement metric for the campaign. As described previously, the types of engagement metric can include a time-to-interact metric or an interaction probability metric. In addition to the engagement metrics, the administrator can also select the specific interaction for the engagement metric. Thus, the administrator can specify that the time-to-interact metric or interaction probability metric corresponds to an open event, select event, click event, redirect event, conversion event, or other user interaction associated with an electronic message.

In one or more embodiments, once the campaign management system 102 has the campaign parameters, the campaign management system 102 partitions past messages within the planning window and trains a recurrent neural network for each user. Then, using each recurrent neural network, the campaign management system 102 generates engagement metrics for the send time bins according to the selected engagement metric type. The campaign management system 102 ranks the time bins based on the engagement metrics and selects the top K time bins according to the message number parameter 502. Additionally, the campaign management system 102 can verify that the top K time bins comply with the message frequency parameter 504.

After determining the time bins for a user based on the campaign parameters, the campaign management system 102 can further group the user with other users that have the same send time schedule based on the determined time bins for the users. As illustrated in FIG. 5A, the campaign management interface 500 includes a cluster region 506 that includes a plurality of clusters (e.g., represented by the circles). Each cluster corresponds to a group of users that have the same send time schedule (e.g., common time bins). The campaign management system 102 can generate as many clusters as there are groups of users with the same send time schedules. Furthermore, the visual sizes of the clusters within the campaign management interface 500 correspond to the number of users within the clusters.

In addition, in one or more embodiments, the campaign management system 102 also displays (e.g., positions) the clusters to indicate a measure of overlap between the send time schedules of different clusters. For example, two clusters that partially overlap in the cluster region 506 can indicate a partial overlap in transmission times (e.g., time bins) within the send time schedules of each cluster. Two additional clusters that overlap to a greater degree in the cluster region 506 can indicate a greater degree of overlap in transmission times (e.g., a greater number of common time bins).

In one or more embodiments, selecting a cluster 508 within the cluster region 506 causes the campaign management interface 500 to display a send time schedule 510 for the cluster. The send time schedule 510 can include a plurality of scheduled times for sending messages in the campaign. As previously described, the campaign management system 102 schedules the messages at times corresponding to the determined time bins for the user(s). Accordingly, the send time schedule 510 can include a plurality of times corresponding to the number of time bins that the campaign management system 102 selected for the cluster of users.

As illustrated in FIG. 5B, selecting a new cluster 512 of users updates the campaign management interface 500 with a new send time schedule 514 for the new cluster 512. The send time schedule 514 for the new cluster 512 can include a different distribution of send times than the send time schedule 510 for the first cluster 508. In particular, the send times for the new cluster 512 are based on the recurrent neural network(s) for the users in the new cluster 512 identifying time bins based on the users' interactions with past electronic messages. Accordingly, each cluster has a different send time schedule with a different distribution of time bins. In one or more embodiments, some clusters can have different numbers of send times in the send time schedule if the users do not have as many time bins that meet a predetermined threshold.

Additionally, changing the campaign parameters can cause the campaign management system 102 to perform new calculations for the users. For example, the administrator can select new campaign parameters (e.g., new planning window, new message number parameter 502 of “5”, and new message frequency parameter 504 of “1”). Specifically, the campaign management system 102 can partition the past electronic messages and train the recurrent neural networks for the users to identify send time schedules for the users according to the new campaign parameters. Analyzing the past electronic messages for the users based on new campaign parameters can result in new clustering of the users according to new send time schedules.

FIG. 5C illustrates another embodiment of the campaign management interface 500 with a cluster region 516 comprising a different arrangement of clusters than the cluster region 506 of FIGS. 5A-5B. As illustrated, selecting a cluster 518 causes the campaign management interface 500 to display a send time schedule 520 for the cluster 518 with the new campaign parameters. Likewise, selecting other clusters in the cluster region 516 can display corresponding send time schedules that also meet the new campaign parameters. The campaign management system 102 can perform a new analysis and generate new clusters of users with different sent time schedules every time the administrator changes the campaign parameters, or based on the administrator changing the campaign parameters and selecting an option to run a new analysis.

Although the description above describes training a recurrent neural network for each user, the campaign management system 102 may alternatively train a recurrent neural network for a group of users. For example, the campaign management system 102 can train a recurrent neural network for a selected target audience that includes users that all have a specific characteristic. When training the recurrent neural network, the campaign management system 102 can combine the past electronic messages and the user interactions for the target audience. Thus, the recurrent neural network can output predicted engagement metrics for the target audience, which can provide processing improvements over training recurrent neural networks for individual users. Additionally, the campaign management system 102 can generate and provide send time schedules for clusters that are based on groups of target audiences (e.g., multiple target audiences that have the same send time schedule).

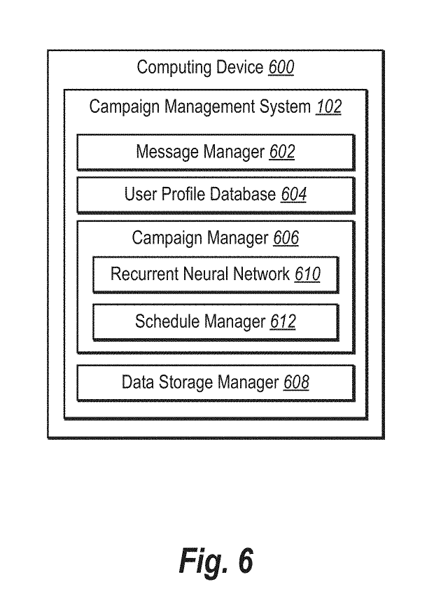

FIG. 6 illustrates a detailed schematic diagram of an embodiment of the campaign management system 102 of FIG. 1. As shown, the campaign management system 102 can be part of computing device(s) 600. Additionally, the campaign management system 102 can include, but is not limited to, a message manager 602, a user profile database 604, a campaign manager 606, and a data storage manager 608. The campaign management system 102 can be implemented on any number of computing devices (e.g., the server device(s) 112 and/or the administrator client device 104 of FIG. 1). For example, the campaign management system 102 can be implemented in a distributed system of server devices for managing digital content campaigns for sending electronic messages such as emails to a plurality of client devices of a plurality of users. Alternatively, the campaign management system 102 can be implemented on a single computing device such as the administrator client device 104 of FIG. 1.

In one or more embodiments, each of the components of the campaign management system 102 are in communication with one another using any suitable communication technologies. Additionally, the components of the campaign management system 102 can be in communication with one or more other devices including the administrator client device 104, as illustrated in FIG. 1. It will be recognized that although the components of the campaign management system 102 are shown to be separate in FIG. 6, any of the subcomponents may be combined into fewer components, such as into a single component, or divided into more components as may serve a particular implementation. Furthermore, although the components of FIG. 6 are described in connection with the campaign management system 102, at least some of the components for performing operations in conjunction with the campaign management system 102 described herein may be implemented on other devices within the environment.

The components of the campaign management system 102 can include software, hardware, or both. For example, the components of the campaign management system 102 can include one or more instructions stored on a computer-readable storage medium and executable by processors of one or more computing devices (e.g., the computing device(s) 600). When executed by the one or more processors, the computer-executable instructions of the campaign management system 102 can cause the computing device(s) 600 to perform the campaign management methods described herein. Alternatively, the components of the campaign management system 102 can comprise hardware, such as a special purpose processing device to perform a certain function or group of functions. Additionally or alternatively, the components of the campaign management system 102 can include a combination of computer-executable instructions and hardware.

Furthermore, the components of the campaign management system 102 performing the functions described herein with respect to the campaign management system 102 may, for example, be implemented as part of a stand-alone application, as a module of an application, as a plug-in for applications including content management applications, as a library function or functions that may be called by other applications, and/or as a cloud-computing model. Thus, the components of the campaign management system 102 may be implemented as part of a stand-alone application on a personal computing device or a mobile device. Alternatively or additionally, the components of the campaign management system 102 may be implemented in any application that allows creation and delivery of marketing content to users, including, but not limited to, applications in ADOBE® ANALYTICS CLOUD, such as ADOBE® ANALYTICS, ADOBE® AUDIENCE MANAGER, ADOBE® CAMPAIGN, ADOBE® EXPERIENCE MANAGER, ADOBE® MEDIA OPTIMIZER, ADOBE® PRIMETIME, ADOBE® SOCIAL, and ADOBE® TARGET. “ADOBE”, “ADOBE ANALYTICS CLOUD”, “ADOBE ANALYTICS”, “ADOBE AUDIENCE MANAGER”, “ADOBE CAMPAIGN”, “ADOBE EXPERIENCE MANAGER”, “ADOBE PRIMETIME”, “ADOBE SOCIAL”, and “ADOBE TARGET” are registered trademarks of Adobe Systems Incorporated in the United States and/or other countries.

As mentioned, the campaign management system 102 can include a message manager 602 to facilitate the management of electronic messages associated with one or more digital content campaigns. Specifically, the message manager 602 can manage the content of electronic messages, the types of electronic messages, and the sending/tracking of electronic messages to one or more recipients. For example, the message manager 602 can track electronic messages that are sent to recipients as part of a digital content campaign and then track user interactions with the messages. Additionally, the message manager 602 can determine characteristics (e.g., based on content, send times, related messages/campaigns) of the electronic messages for use by the campaign manager 606. The message manager 602 can communicate with the data storage manager 608 to store past electronic messages previously sent to recipients and new electronic messages to be sent to recipients.

The message manager 602 can also partition electronic messages into time bins for use by the campaign manager 606. Specifically, the message manager 602 can receive information about a campaign (e.g., campaign parameters such as a planning window, analysis window, number of messages, frequency of messages) and then partition past electronic messages into a plurality of time bins. The message manager 602 can partition the messages equally across the time bins or in using other partitioning methods, such as within specific time windows.

The campaign management system 102 also includes a user profile database 604 to facilitate the management and storing of user profile information associated with a plurality of recipient users. For example, the user profile database 604 can include a user profile for each user in a plurality of users to which the campaign management system 102 has sent messages or will send messages. A user profile can include personal information about a user (e.g., user demographics), as well as information indicating the user's historical interactions with electronic messages, user interests, and user preferences. The user profile database 604 can update a user profile as new information associate with the corresponding user becomes available (e.g., in response to new user interactions or changed user information).

In one or more embodiments, the campaign management system 102 includes a campaign manager 606 to manage digital content campaigns for one or more entities. In particular, the campaign manager 606 can manage a plurality of digital content campaigns for a plurality of entities that provide marketing messages or informational messages via one or more digital content campaigns to a plurality of users. Additionally, the campaign manager 606 can provide access to campaign data to campaign administrators in connection with managing and executing campaigns.

The campaign manager 606 can also provide analysis and predictive information associated with executing campaigns. For example, the campaign manager 606 can include a recurrent neural network 610 for generating predicted engagement metrics associated with new electronic messages to be sent to a user. The campaign manager 606 can train the recurrent neural network 610 based on past electronic messages and then utilize the recurrent neural network 610 to generate the predicted engagement metrics for time bins, as determined by the message manager 602. The campaign manager 606 can also include a plurality of recurrent neural networks (e.g., one for each user or for each target audience) to generate predicted engagement metrics.

The campaign manager 606 can include a schedule manager 612 that uses the predicted engagement metrics to determine transmission times for sending new electronic messages in one or more digital content campaigns. In particular, the schedule manager 612 can rank time bins based on the predicted engagement metrics. Furthermore, the schedule manager 612 can use campaign parameters to determine a plurality of transmission times based on the ranked time bins for generating a send schedule for a user or group of users. The schedule manager 612 can also assist a campaign administrator in executing the digital content campaign by communicating with the message manager to send messages at transmission times according to a send schedule.

The campaign management system 102 also includes a data storage manager 608 (that comprises a non-transitory computer memory) that stores and maintains data associated with digital content campaigns. For example, the data storage manager 608 can include a database that stores a plurality of past electronic messages for each user. Additionally, the data storage manager 608 can store information associated with the users, such as user profiles and user interaction information associated with a user's interactions with the past electronic messages. Furthermore, the data storage manager 608 can store one or more recurrent neural networks 610 for one or more users.

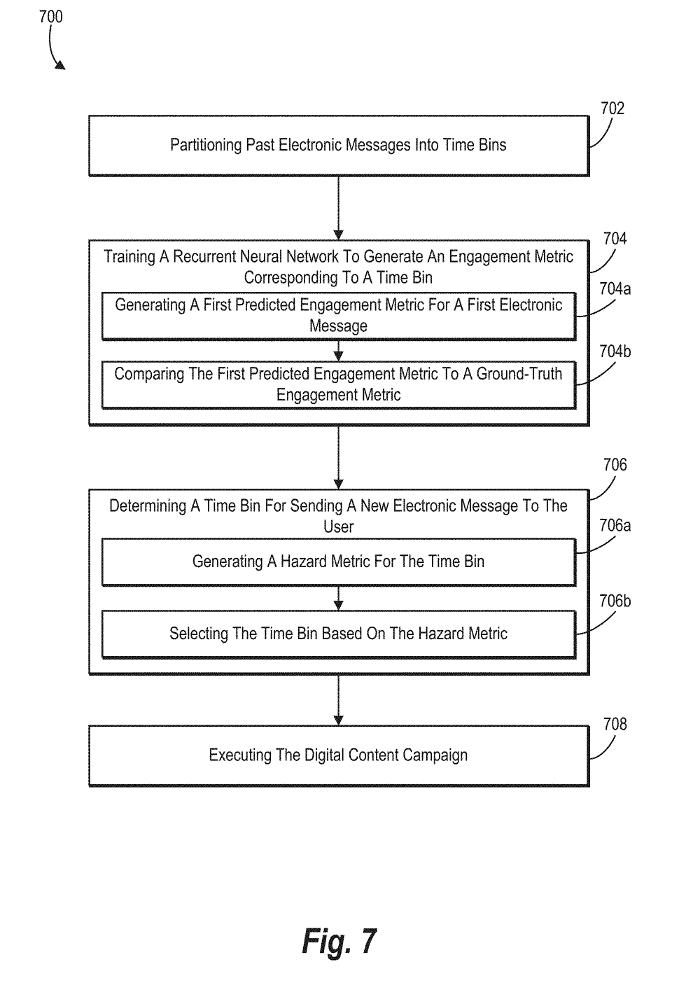

Turning now to FIG. 7, this figure illustrates a flowchart of a series of acts 700 of determining and applying strategic digital content transmission times using machine-learning. While FIG. 7 illustrates acts according to one embodiment, alternative embodiments may omit, add to, reorder, and/or modify any of the acts shown in FIG. 7. The acts of FIG. 7 can be performed as part of a method. Alternatively, a non-transitory computer readable medium can comprise instructions, that when executed by one or more processors, cause a computing device to perform the acts of FIG. 7. In still further embodiments, a system can perform the acts of FIG. 7.

The series of acts 700 includes an act 702 of partitioning past electronic messages into time bins. For example, act 702 involves partitioning a plurality of past electronic messages into a plurality of time bins, wherein the plurality of past electronic messages comprises past electronic messages for a user. Act 702 can involve determining a planning window for a digital content campaign, and, based on the planning window, generating the time bins such that the time bins span the planning window and the plurality of past electronic messages are divided among the time bins according to a grouping proportion. For example, the grouping proportion can include an equal division of past electronic messages across the plurality of time bins.

The series of acts 700 also includes an act 704 of training a recurrent neural network to generate an engagement metric corresponding to a time bin. For example, act 704 involves analyzing the past electronic messages via a recurrent neural network according to the sequential order to train the recurrent neural network to generate an engagement metric corresponding to a time bin for a new electronic message to the user.

As part of act 704, the series of acts 700 include an act 704a of generating a first predicted engagement metric for a first electronic message. For example, act 704a involves generating a first predicted engagement metric for a first electronic message of the past electronic messages for the user based on a first time bin corresponding to the first electronic message. For example, the first predicted engagement metric can include a first predicted hazard metric, and the first predicted hazard metric indicates an instantaneous probability of a user interaction with the first electronic message resulting from sending the first electronic message to the user within the first time bin.

As part of act 704, the series of acts 700 also includes an act 704b of comparing the first predicted engagement metric to a ground-truth engagement metric. For example, act 704b involves comparing the first predicted engagement metric for the first electronic message to a ground-truth engagement metric for the first electronic message.

As part of act 704, the series of acts 700 can include an act of providing, as input to the recurrent neural network, input attributes associated with the first electronic message, the input attributes comprising user interactions with at least one past electronic message sent prior to the first electronic message and the first time bin corresponding to the first electronic message.

The series of acts 700 can also include an act of generating a second predicted engagement metric for a second electronic message of the past electronic messages for the user based on a second time bin corresponding to the second electronic message. The series of acts 700 can then include an act of comparing the second predicted engagement metric for the second electronic message to a ground-truth engagement metric for the second electronic message. Additionally, the series of acts 700 can include an act of generating sequence data corresponding to the first electronic message, and further comprising instructions that, when executed by the at least one processor, cause the system to generate the second predicted engagement metric based on the sequence data corresponding to the first electronic message.

The series of acts 700 can further include an act of providing for display, within a user interface of an administrator client device, an option to select an interaction probability type of engagement metric or a hazard type of engagement metric. The series of acts 700 can also include an act of receiving, from the administrator client device, an indication of a selection of the hazard type of engagement metric. The series of acts 700 can additionally include an act of training the recurrent neural network utilizing the first predicted hazard metric based on the selection of the hazard type of engagement metric.

The series of acts 700 also includes an act 706 of determining a time bin for sending a new electronic message to the user. For example, act 706 involves for a digital content campaign comprising a new electronic message for the user, determining a time bin of the plurality of time bins for sending the new electronic message to a client device of the user.

As part of act 706, the series of acts 700 also includes an act 706a of generating a hazard metric for the time bin. For example, act 706a involves generating, for the time bin, a hazard metric using a recurrent neural network trained on the past electronic messages to the user, wherein the hazard metric indicates an instantaneous probability of a user interaction with the new electronic message resulting from sending the new electronic message to the user within the time bin.

As part of act 706, the series of acts 700 includes an act 706b of selecting the time bin based on the hazard metric. For example, act 706b involves selecting the time bin from the plurality of time bins based on the hazard metric for the time bin.

Additionally, act 706 can also involve generating, for a second time bin of the plurality of time bins, a second hazard metric for the new message to the user using the recurrent neural network trained on the past electronic messages to the user. Act 706 can involve selecting the time bin from the plurality of time bins by comparing the hazard metric for the first time bin and the second hazard metric for the second time bin. Act 706 can further involve selecting the second time bin by comparing the first time bin and the second time bin to a frequency parameter that limits a frequency of sending electronic messages to the client device of the user.

The series of acts 700 can also include determining, utilizing the recurrent neural network, a subset of time bins for sending a plurality of electronic messages to the client device of the user. The series of acts 700 can then include generating a send schedule for sending the plurality of electronic messages according to the determined subset of time bins.

Additionally, the series of acts 700 includes an act 706 of executing the digital content campaign. For example, act 706 involves executing the digital content campaign by sending the new electronic message to the client device of the user based on the determined time bin. Act 706 can involve executing the digital content campaign in response to a request to initiate the digital content campaign from an administrator client device.

Additionally, the series of acts 700 can include an act of executing the digital content campaign by sending the plurality of electronic messages to the client device of the user according to a send schedule for the user. The series of acts 700 can also include grouping the user into a cluster of users corresponding to the send schedule, and presenting, within a user interface of the administrator client device, the cluster of users with the send schedule.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 8 illustrates a block diagram of exemplary computing device 800 that may be configured to perform one or more of the processes described above. One will appreciate that one or more computing devices such as the computing device 800 may implement the campaign management system 102. As shown by FIG. 8, the computing device 800 can comprise a processor 802, a memory 804, a storage device 806, an I/O interface 808, and a communication interface 810, which may be communicatively coupled by way of a communication infrastructure 812. In certain embodiments, the computing device 800 can include fewer or more components than those shown in FIG. 8. Components of the computing device 800 shown in FIG. 8 will now be described in additional detail.

In one or more embodiments, the processor 802 includes hardware for executing instructions, such as those making up a computer program. As an example and not by way of limitation, to execute instructions for dynamically modifying workflows, the processor 802 may retrieve (or fetch) the instructions from an internal register, an internal cache, the memory 804, or the storage device 806 and decode and execute them. The memory 804 may be a volatile or non-volatile memory used for storing data, metadata, and programs for execution by the processor(s). The storage device 806 includes storage, such as a hard disk, flash disk drive, or other digital storage device, for storing data or instructions for performing the methods described herein.

The I/O interface 808 allows a user to provide input to, receive output from, and otherwise transfer data to and receive data from computing device 800. The I/O interface 808 may include a mouse, a keypad or a keyboard, a touch screen, a camera, an optical scanner, network interface, modem, other known I/O devices or a combination of such I/O interfaces. The I/O interface 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 808 is configured to provide graphical data to a display for presentation to a user. The graphical data may be representative of one or more graphical user interfaces and/or any other graphical content as may serve a particular implementation.

The communication interface 810 can include hardware, software, or both. In any event, the communication interface 810 can provide one or more interfaces for communication (such as, for example, packet-based communication) between the computing device 800 and one or more other computing devices or networks. As an example and not by way of limitation, the communication interface 810 may include a network interface controller (NIC) or network adapter for communicating with an Ethernet or other wire-based network or a wireless NIC (WNIC) or wireless adapter for communicating with a wireless network, such as a WI-FI.

Additionally, the communication interface 810 may facilitate communications with various types of wired or wireless networks. The communication interface 810 may also facilitate communications using various communication protocols. The communication infrastructure 812 may also include hardware, software, or both that couples components of the computing device 800 to each other. For example, the communication interface 810 may use one or more networks and/or protocols to enable a plurality of computing devices connected by a particular infrastructure to communicate with each other to perform one or more aspects of the processes described herein. To illustrate, the digital content campaign management process can allow a plurality of devices (e.g., a client device and server devices) to exchange information using various communication networks and protocols for sharing information such as electronic messages, user interaction information, engagement metrics, or campaign management resources.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. In a digital medium environment for executing digital content campaigns across a plurality of computing devices, a computer-implemented method of determining and applying strategic digital content transmission times using machine-learning, comprising:
identifying, by at least one processor, past electronic messages for a user partitioned into a plurality of time bins based on timestamps corresponding to the past electronic messages;
a step for utilizing a recurrent neural network and the past electronic messages for the user to determine a time bin of the plurality of time bins for sending a new electronic message for the user; and
executing a digital content campaign by sending the new electronic message to a client device of the user based on the determined time bin.

2. The computer-implemented method as recited in claim 1, wherein identifying the past electronic messages for the user partitioned into the plurality of time bins comprises partitioning a plurality of past electronic messages of a plurality of users into the plurality of time bins according to a grouping proportion.

3. The computer-implemented method as recited in claim 1, wherein the step for utilizing the recurrent neural network comprises utilizing the recurrent neural network to generate an interaction probability metric for a time bin of the plurality of time bins, the interaction probability metric indicating a probability of a user interaction with the new electronic message.

4. The computer-implemented method as recited in claim 1, wherein the step for utilizing the recurrent neural network comprises utilizing the recurrent neural network to generate a hazard metric for the time bin of the plurality of time bins, the hazard metric indicating an instantaneous probability of a user interaction with the new electronic message upon sending the new electronic message to the client device of the user within the time bin.

5. The computer-implemented method as recited in claim 4, wherein the step for utilizing the recurrent neural network comprises utilizing the recurrent neural network to generate the hazard metric for the time bin based on a survival function embedded in the recurrent neural network.

6. A system for determining and applying strategic digital content transmission times for digital content campaigns using machine-learning, comprising:
at least one processor; and
a non-transitory computer memory comprising a plurality of past electronic messages comprising past electronic messages for a user sent in a sequential order; and
instructions that, when executed by the at least one processor, cause the system to:
partition the plurality of past electronic messages into a plurality of time bins; and
analyze the past electronic messages via a recurrent neural network according to the sequential order to train the recurrent neural network to generate an engagement metric corresponding to a time bin for a new electronic message to the user by:
generating a first predicted engagement metric for a first electronic message of the past electronic messages for the user based on a first time bin corresponding to the first electronic message; and
comparing the first predicted engagement metric for the first electronic message to a ground-truth engagement metric for the first electronic message.

7. The system as recited in claim 6, further comprising instructions that, when executed by the at least one processor cause the system to partition the plurality of past electronic messages into the plurality of time bins by:
determining a planning window for a digital content campaign; and
based on the planning window, generating the time bins such that the time bins span the planning window and the plurality of past electronic messages are divided among the time bins according to a grouping proportion.

8. The system as recited in claim 6, further comprising instructions that, when executed by the at least one processor, cause the system to train the recurrent neural network by:
generating a second predicted engagement metric for a second electronic message of the past electronic messages for the user; and
compare the second predicted engagement metric for the second electronic message to a ground-truth engagement metric for the second electronic message.

9. The system as recited in claim 8, wherein generating the first predicted engagement metric further comprises generating sequence data corresponding to the first electronic message, and further comprising instructions that, when executed by the at least one processor, cause the system to generate the second predicted engagement metric based on the sequence data corresponding to the first electronic message.

10. The system as recited in claim 6, further comprising instructions that, when executed by the at least one processor, cause the system to train the recurrent neural network by providing, as input to the recurrent neural network, input attributes associated with the first electronic message, the input attributes comprising user interactions with at least one past electronic message sent prior to the first electronic message and the first time bin corresponding to the first electronic message.

11. The system as recited in claim 6, wherein the first predicted engagement metric comprises a first predicted hazard metric, and the first predicted hazard metric indicates an instantaneous probability of a user interaction with the first electronic message resulting from sending the first electronic message to the user within the first time bin.

12. The system as recited in claim 11, further comprising instructions that, when executed by the at least one processor, cause the system to:
provide for display, within a user interface of an administrator client device, an option to select an interaction probability type of engagement metric or a hazard type of engagement metric;
receive, from the administrator client device, an indication of a selection of the hazard type of engagement metric; and
train the recurrent neural network utilizing the first predicted hazard metric based on the selection of the hazard type of engagement metric.

13. In a digital medium environment for executing digital content campaigns across a plurality of computing devices, a computer-implemented method for determining and applying strategic digital content transmission times using machine-learning:
partitioning, by at least one processor, a plurality of past electronic messages into a plurality of time bins, wherein the plurality of past electronic messages comprises past electronic messages for a user;
for a digital content campaign comprising a new electronic message for the user, determining a time bin of the plurality of time bins for sending the new electronic message to a client device of the user by:
generating, for the time bin, a hazard metric using a recurrent neural network trained on the past electronic messages to the user, wherein the hazard metric indicates an instantaneous probability of a user interaction with the new electronic message resulting from sending the new electronic message to the user within the time bin; and
selecting the time bin from the plurality of time bins based on the hazard metric for the time bin; and
executing the digital content campaign by sending the new electronic message to the client device of the user based on the determined time bin.

14. The computer-implemented method as recited in claim 13, further comprising partitioning the plurality of past electronic messages into the plurality of time bins according to a grouping proportion, wherein the grouping proportion comprises an equal division of past electronic messages across the plurality of time bins.

15. The computer-implemented method as recited in claim 13, further comprising:
generating, for a second time bin of the plurality of time bins, a second hazard metric for the new electronic message to the user using the recurrent neural network trained on the past electronic messages for the user; and
selecting the time bin from the plurality of time bins by comparing the hazard metric for the time bin and the second hazard metric for the second time bin.

16. The computer-implemented method as recited in claim 15, further comprising selecting the second time bin by comparing the time bin and the second time bin to a frequency parameter that limits a frequency of sending electronic messages to the client device of the user.

17. The computer-implemented method as recited in claim 13, further comprising:
determining, utilizing the recurrent neural network, a subset of time bins for sending a plurality of electronic messages to the client device of the user; and
generating a send schedule for sending the plurality of electronic messages according to the determined subset of time bins.

18. The computer-implemented method as recited in claim 17, further comprising executing the digital content campaign by sending the plurality of electronic messages to the client device of the user according to the send schedule.

19. The computer-implemented method as recited in claim 17, further comprising:
grouping the user into a cluster of users corresponding to the send schedule; and
presenting, within a user interface of an administrator client device, the cluster of users with the send schedule.

20. The computer-implemented method as recited in claim 13, further comprising utilizing the recurrent neural network to:
train the recurrent neural network by generating a predicted hazard metric for a first electronic message of the plurality of past electronic messages;
generate sequence data corresponding to the first electronic message; and
generate the hazard metric for the new electronic message and the time bin based on the generated sequence data corresponding to the first electronic message.
